(19) United States
(12) Patent Application Publication
(10) Pub. No.: US 2026/0181557 A1
(43) Pub. Date: Jun. 25, 2026

(54) LINK INFORMATION ACQUISITION METHODS AND APPARATUSES, DEVICES AND MEDIUM

(71) Applicant: GUANGDONG OPPO MOBILE TELECOMMUNICATIONS CORP., LTD., Dongguan (CN)

(72) Inventor: Rongyi HU, Dongguan (CN)

(21) Appl. No.: 19/545,272

(22) Filed: Feb. 20, 2026

Related U.S. Application Data
(63) Continuation of application No. PCT/CN2023/125079, filed on Oct. 17, 2023.

(51) Int. Cl. H04W 52/02

(52) U.S. Cl. CPC H04W 52/0251

(57) ABSTRACT

Disclosed is a method for acquiring link information. The method for acquiring link information is performed by a first device and includes: acquiring state information of a power link based on a measurement result of a first signal and/or a measurement result of a second signal; where the first signal is from an A-IoT device, the second signal is transmitted by the first device on the power link, and the power link is used to supply power to the A-IoT device.

### CROSS-REFERENCE TO RELATED APPLICATION

This application is a Continuation application of International Application No. PCT/CN2023/125079 filed on Oct. 17, 2023, which is incorporated herein by reference in its entirety.

### TECHNICAL FIELD

The present application relates to the field of communications, and more particularly, to a method for acquiring link information, an apparatus, a device, and a medium.

### BACKGROUND

If it is expected that a terminal device uses power harvested from the environment (e.g., radio frequency power) to achieve communication, a link for supplying power needs to be monitored or maintained in order to ensure communication efficiency and stability.

### SUMMARY

The present application provides a method for acquiring link information, an apparatus, a device, and a medium, and the technical solutions include at least the following.

According to an aspect of the embodiments of the present application, a method for acquiring link information is provided. The method is performed by a first device and includes:
acquiring state information of a power link based on a measurement result of a first signal and/or a measurement result of a second signal;
where the first signal is from a zero-power device, the second signal is transmitted by the first device on the power link, and the power link is used to supply power to the zero-power device.

According to another aspect of the embodiments of the present application, a method for acquiring link information is provided. The method is performed by a zero-power device and includes:
transmitting or backscattering a signal;
where the signal and/or information carried in the signal is used to acquire state information of a power link, and the power link is used to supply power to the zero-power device.

According to another aspect of the embodiments of the present application, a method for acquiring link information is provided. The method is performed by a second device, and includes:
transmitting a measurement result of a first signal, and/or a measurement result of a second signal, and/or feedback information;
where the measurement result of the first signal is used to acquire state information of a power link, the measurement result of the second signal is used to acquire the state information of the power link, the feedback information is used to acquire the state information of the power link, and the power link is used to supply power to a zero-power device.

According to another aspect of the embodiments of the present application, an apparatus for acquiring link information is provided, which includes:
a processing module, configured to acquire state information of a power link based on a measurement result of a first signal and/or a measurement result of a second signal;
where the first signal is from a zero-power device, the second signal is transmitted by the apparatus on the power link, and the power link is used to supply power to the zero-power device.

According to another aspect of the embodiments of the present application, an apparatus for acquiring link information is provided, which includes:
a transmitting module, configured to transmit or backscatter a signal;
where the signal and/or information carried in the signal is used to acquire state information of a power link, and the power link is used to supply power to the apparatus.

According to another aspect of the embodiments of the present application, an apparatus for acquiring link information is provided, which includes:
a transmitting module, configured to transmit a measurement result of a first signal, and/or a measurement result of a second signal, and/or feedback information;
where the measurement result of the first signal is used to acquire state information of a power link, the measurement result of the second signal is used to acquire the state information of the power link, the feedback information is used to acquire the state information of the power link, and the power link is used to supply power to a zero-power device.

According to an aspect of the embodiments of the present application, a communication device is provided, which includes:
a processor;
a receiver and/or a transmitter connected to the processor; and
a memory configured to store executable instructions of the processor;
where the communication device is configured to implement the method for acquiring link information described above.

According to another aspect of the embodiments of the present application, a communication device is provided, which includes: a receiver and/or a transmitter;
where the communication device is configured to implement the method for acquiring link information described above.

According to an aspect of the present application, a non-transitory computer-readable storage medium is provided. The non-transitory computer-readable storage medium has executable instructions stored thereon, and the executable instructions are loaded and executed by a processor to implement the method for acquiring link information described above.

According to an aspect of the present application, a computer program product is provided, which includes computer instructions. The computer instructions are stored in a non-transitory computer-readable storage medium, a processor of a computer device reads the computer instructions from the non-transitory computer-readable storage medium, and the processor executes the computer instructions to enable the computer device to perform the method for acquiring link information described above.

According to an aspect of the present application, a chip is provided, which includes a programmable logic circuitry and/or program instructions. The chip, when running, is configured to implement the method for acquiring link information described above.

According to an aspect of the present application, a computer program is provided, which includes computer instructions. A processor of a computer device executes the computer instructions, to enable the computer device to perform the method for acquiring link information described above.

### BRIEF DESCRIPTION OF THE DRAWINGS

To more clearly illustrate the technical solutions in the embodiments of the present application, accompanying drawings required in the description of the embodiments will be briefly introduced below. It is apparent that the accompanying drawings described below are merely some embodiments of the present application. For those skilled in the art, other drawings can also be obtained according to these accompanying drawings.

FIG. 1 illustrates a schematic diagram of a wireless communication system provided in an exemplary embodiment of the present application.

FIG. 2 illustrates a schematic diagram of a communication system provided in an exemplary embodiment of the present application.

FIG. 3 illustrates a schematic diagram of radio frequency power harvesting provided in an exemplary embodiment of the present application.

FIG. 4 illustrates a schematic diagram of a backscatter communication process provided in an exemplary embodiment of the present application.

FIG. 5 illustrates a schematic diagram of resistive load modulation provided in an exemplary embodiment of the present application.

FIG. 6 illustrates a flowchart of a method for acquiring link information provided in an exemplary embodiment of the present application.

FIG. 7 illustrates a flowchart of a method for acquiring link information provided in an exemplary embodiment of the present application.

FIG. 8 illustrates a flowchart of a method for acquiring link information provided in an exemplary embodiment of the present application.

FIG. 9 illustrates a schematic diagram of a transmission period provided in an exemplary embodiment of the present application.

FIG. 10 illustrates a schematic diagram of a transmission period provided in an exemplary embodiment of the present application.

FIG. 11 illustrates a schematic diagram of transmit power provided in an exemplary embodiment of the present application.

FIG. 12 illustrates a schematic diagram of transmission time domain resources of a first signal and a second signal provided in an exemplary embodiment of the present application.

FIG. 13 illustrates a flowchart of a method for acquiring link information provided in an exemplary embodiment of the present application.

FIG. 14 illustrates a flowchart of a method for acquiring link information provided in an exemplary embodiment of the present application.

FIG. 15 illustrates a flowchart of a method for acquiring link information provided in an exemplary embodiment of the present application.

FIG. 16 illustrates a flowchart of a method for acquiring link information provided in an exemplary embodiment of the present application.

FIG. 17 illustrates a schematic diagram of a method for acquiring link information provided in an exemplary embodiment of the present application.

FIG. 18 illustrates a schematic diagram of a method for acquiring link information provided in an exemplary embodiment of the present application.

FIG. 19 illustrates a schematic diagram of a method for acquiring link information provided in an exemplary embodiment of the present application.

FIG. 20 illustrates a structural block diagram of an apparatus for acquiring link information provided in an exemplary embodiment of the present application.

FIG. 21 illustrates a structural block diagram of an apparatus for acquiring link information provided in an exemplary embodiment of the present application.

FIG. 22 illustrates a structural block diagram of an apparatus for acquiring link information provided in an exemplary embodiment of the present application.

FIG. 23 illustrates a schematic structural diagram of a communication device provided in an exemplary embodiment of the present application.

FIG. 24 illustrates a schematic structural diagram of a communication device provided in an exemplary embodiment of the present application.

### DETAILED DESCRIPTION

To make objectives, technical solutions and advantages of the present application clearer, implementations of the present application will be described in further detail below with reference to the accompanying drawings. Exemplary embodiments, examples of which are illustrated in the accompanying drawings, will be described in detail here. When the following description refers to the accompanying drawings, the same numerals in different accompanying drawings represent the same or similar elements unless otherwise indicated. The implementations described in the following exemplary embodiments do not represent all implementations consistent with the present application. Rather, they are merely examples of apparatus and methods consistent with some aspects of the present application as detailed in appended claims.

The terms used in the present application are merely for the purpose of describing particular embodiments, and are not intended to limit the present application. As used in the present application and the appended claims, the singular forms “a/an”, “the” and “the said” are also intended to include the plural forms, unless context clearly indicates otherwise. It should also be understood that the term “and/or” as used herein refers to and includes any or all possible combinations of one or more associated listed items.

It should be understood that although the terms “first”, “second”, “third” or the like may be used in the present application to describe various types of information, such information should not be limited to these terms. These terms are merely used to distinguish the same type of information from each other. For example, without departing from the scope of the present application, first information may also be referred to as second information, and similarly, second information may also be referred to as first information. Depending on the context, the phrase “if” as used herein may be interpreted as “when” or “while” or “in response to determining”.

Even with the rapid development of cellular Internet of Things to date, there remain some scenarios where the communication requirements of IoT cannot be met, such as:

### 1. Harsh Communication Environment

Some IoT scenarios may face extreme environments such as high temperature, extremely low temperature, high humidity, high pressure, high radiation or high speed, for example, ultra-high voltage substations, high-speed train track monitoring, high-altitude and cold region environmental monitoring and industrial production lines. In these scenarios, ordinary IoT terminals will be unable to function due to the working environmental constraints on conventional power supplies. Furthermore, in extreme working environments, it is difficult to replace batteries for IoT terminals, which is also detrimental to the inspection and maintenance of IoT systems.

### 2. Requirement for Extremely Small Size Terminal Form Factors

In certain IoT communication scenarios, such as food traceability, commodity circulation and smart wearables, terminals are required to have extremely small sizes. For example, IoT terminals used for commodity management in the circulation process typically take the form of electronic tags, which are embedded into product packaging in a very small form. For example, lightweight wearable devices may enhance the user experience while meeting user requirements.

### 3. Requirement for Extremely Low-Cost IoT Communication

Numerous IoT communication scenarios require the cost of IoT terminals to be low enough to enhance their competitiveness relative to other alternative technologies. In logistics or warehousing scenarios, to facilitate the management of a large number of circulating goods, IoT terminals may be attached to each piece of goods, thereby enabling precise management of the entire logistics process and lifecycle through communications between the terminal and the logistics network. These scenarios require IoT terminal pricing to be sufficiently competitive.

Therefore, in order to address the above unmet IoT communication requirements, zero-power devices with many advantages such as conventional battery-free, maintenance-free, small size, low complexity, low cost and long life cycle have received widespread attention.

The zero-power device is also referred to as an ultra-low-power device, a low-power device, a passive IoT device, or an ambient power enabled Internet of Things (Ambient IoT/A-IoT) device.

The communication technology implemented through the zero-power devices may be referred to as zero-power communication technology, ultra-low-power communication technology, low-power communication technology, ambient power enabled Internet of Things (Ambient IoT/A-IT) technology, passive IoT technology, or zero-power IoT technology.

The zero-power devices may harvest power from the environment (e.g., radio frequency power, solar power, light power, thermal power, mechanical power, or kinetic power) to obtain power for communication. Generally, based on the power source and usage manner, the zero-power devices may be divided into the following three types.

(1) Passive device: the passive device does not need a built-in battery. When the passive device approaches a network device (e.g., a reader/writer of a radio frequency identification (RFID) system), the passive device is located within a near-field range formed by radiation of an antenna of the network device. Therefore, the antenna of the passive device generates an induced current through electromagnetic induction, and the induced current drives a low-power chip circuit of the passive device, to implement the operations such as signal demodulation of a forward link and signal modulation of a backward link. For a backscatter link, the passive device may transmit signals using either backscattering or extremely low-power active transmission manners. The passive device does not need the built-in battery to drive, either for the forward link or the reverse link, and therefore, the passive device may be considered as a zero-power device.

In addition to not requiring batteries, the radio frequency circuit and baseband circuit are both very simple. For example, the passive device does not need components such as a low-noise amplifier (LNA), a power amplifier (PA), a crystal oscillator and an analog-to-digital conversion (ADC), so that the passive device has many advantages such as small size, light weight, extremely low price and long service life.

The passive device may also support other power harvesting manners. By harvesting power from the environment (e.g., solar power, light power, thermal power, kinetic power, or mechanical power), the passive device may obtain power to drive circuits, so as to achieve communication.

(2) Semi-passive device: the semi-passive device itself is not installed with a conventional battery, but may use a radio frequency power harvesting module to harvest radio wave power, or use a power harvesting module to harvest power from the environment (e.g., solar power, light power, thermal power, kinetic power, or mechanical power), and simultaneously, the semi-passive device stores the harvested power in a power storage unit (e.g., a capacitor). After obtaining power, the power storage unit may drive a low-power chip circuit of the semi-passive device, to implement the operations such as signal demodulation of a forward link and signal modulation of a backward link. For a backscattering link, the semi-passive device may transmit signals using backscattering. The semi-passive device may also have the capability of active transmission, that is, in addition to communicating by a backscattering manner, it may also communicate on the backward link by an active transmission manner.

The semi-passive device does not need the built-in battery to drive either the forward link or the backward link. Although the power stored in the capacitor is used during operation, the power is from the radio power or ambient power harvested by the power harvesting module. Therefore, the semi-passive device may also be considered as a zero-power device.

The semi-passive device inherits many advantages of the passive device, such as small size, light weight, extremely low price, and long service life.

(3) Active device: the active device may have a built-in battery. The battery is used to drive a low-power chip circuitry of the active device, to implement the operations such as signal demodulation of a forward link and signal modulation of a backward link. Signal transmission on the backward link of the active device may achieve the effect of zero power consumption by using a backscattering manner without consuming the power of the active device itself. The active device may also have the capability of active transmission, that is, in addition to communicating by a backscattering manner, it may communicate on the backward link by an active transmission manner.

Although equipped with built-in batteries, the active devices has extremely low power consumption and complexity, so the battery capacity can be set within a small range, thereby achieving lower cost and size. The built-in battery in the active device may also serve as a power storage unit to store the ambient power harvested by the power harvesting module. This results in a longer maintenance cycle for the active device, or even maintenance-free.

In the active device, the built-in battery is used to increase the communication range, such as increasing a read-write distance of the electronic tag, to improve communication reliability. Therefore, the active device may be applied in some scenarios that have relatively high requirements for aspects such as communication distance and read latency.

In terms of communication manners, the zero-power device may support backscattering and/or active transmission communication manners. Generally, based on the transmitter types, the zero-power device may be divided into the following three types.

(1) Backscattering-based zero-power device: such type of devices uses the backscattering manner described above for uplink data transmission. Such type of devices does not have an active transmitter for active transmission, but only a transmitter for backscattering. Therefore, when such type of devices perform uplink data transmission, a network device is required to provide a carrier, and such type of devices performs backscattering based on the carrier to implement uplink data transmission.

(2) Active transmitter-based zero-power device: such type of devices uses an active transmitter with active transmission capability for uplink data transmission. Therefore, when transmitting uplink data, such type of devices may use their own active transmitters to transmit uplink data without the need for the network device to provide a carrier. The active transmitter suitable for such type of devices may be, for example, an ultra-low power ASK transmitter, an ultra-low power FSK transmitter. Based on current implementations, when transmitting a 100-microwatt signal, the overall power consumption of such type of transmitters may be reduced to 400 to 600 microwatts.

(3) Zero-power device with both backscattering and active transmitter: such type of devices may support both backscattering and an active transmitter. Such type of devices may determine whether to use a backscattering manner or an active transmitter for active transmission, according to different situations (e.g., different power levels or different available ambient power source) or based on scheduling of the network device.

FIG. 1 illustrates a schematic diagram of a wireless communication system provided by an exemplary embodiment of the present application. The wireless communication system includes a network device 110 and a terminal device 120, and/or a terminal device 120 and a terminal device 130, which are not limited in the present application.

The network device 110 in the present application provides wireless communication functionality. The network device 110 includes, but is not limited to, an evolved node B (eNB), a radio network controller (RNC), a node B (NB), a base station controller (BSC), a base transceiver station (BTS), a home base station (e.g., a home evolved node B, or a home node B (HNB)), a baseband unit (BBU), an access point (AP) in a wireless fidelity (Wi-Fi) system, a wireless relay node, a wireless backhaul node, a transmission point (TP), or a transmission and reception point (TRP), or the like. The network device 110 may also be a next generation node B (gNB) or a transmission point (TRP or TP) in a 5th Generation (5G) mobile communication system, or one or a group of antenna panels (including multiple antenna panels) of a base station in a 5G system, or a network node constituting a gNB or a transmission point, such as a baseband unit (BBU) or a distributed unit (DU), or a base station in a beyond fifth generation (B5G) mobile communication system or a 6th generation (6G) mobile communication system, or a core network (CN), fronthaul, backhaul, a radio access network (RAN), a network slicing, or a reader/writer of a radio frequency identification (RFID) system.

The terminal device 120 and/or terminal device 130 in the present application is also referred to as a user equipment (UE), an access terminal, a user unit, a user station, a mobile station, a mobile platform, a remote station, a remote terminal, a mobile device, a user terminal, a terminal, a wireless communication device, a user agent, or a user apparatus. The terminal includes, but is not limited to, a handheld device, a wearable device, an in-vehicle device, and a IoT device, such as, an electronic tag, a controller, a mobile phone, a pad, an e-reader, a laptop, a desktop computer, a television, a game console, a mobile internet device (MID), an augmented reality (AR) terminal, a virtual reality (VR) terminal, a mixed reality (MR) terminal, a wearable device, a hand shank, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, a wireless terminal in remote medical surgery, a cellular phone, a cordless phone, a session initiation protocol (SIP) phone, a wireless local loop (WLL) station, a personal digital assistant (PDA), a set top box (STB), a customer premise equipment (CPE).

The network device 110 and the terminal device 120 communicate with each other through a certain air interface technology, such as a Uu interface.

For example, there are two communication scenarios between the network device 110 and the terminal device 120: an uplink communication scenario and a downlink communication scenario. The uplink communication refers to transmitting signals to the network device 110; and the downlink communication refers to transmitting signals to the terminal device 120.

The terminal device 120 and terminal device 130 communicate with each other through a certain direct communication interface, such as a PC5 interface.

In some embodiments, there are two communication scenarios between the terminal device 120 and the terminal device 130: a first sidelink communication scenario and a second sidelink communication scenario. The first sidelink communication refers to transmitting signals to the terminal device 130; and the second sidelink communication refers to transmitting signals to the terminal device 120.

The terminal device 120 and the terminal device 130 are both within the network coverage and located in the same cell, or the terminal device 120 and the terminal device 130 are both within the network coverage but located in different cells, or the terminal device 120 is within the network coverage but the terminal device 130 is outside the network coverage.

In some embodiments, the terminal device 120 is implemented as the zero-power device described above, and/or the terminal device 130 is implemented as the zero-power device described above. The terminal device 120 is also referred to as an ultra-low power device, a low power device, a passive IoT device, or an A-IoT device. The terminal device 130 is also referred to as an ultra-low power device, a low power device, a passive IoT device, or an A-IoT device.

The technical solutions provided in the embodiments of the present application may be applied to various communication systems, such as, a global system of mobile communication (GSM) system, a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced long term evolution (LTE-A) system, a universal mobile telecommunication system (UMTS), a worldwide interoperability for microwave access (WiMAX) communication system, a 5G mobile communication system, a new radio (NR) system, an evolution system of an NR system, an LTE-based access to unlicensed spectrum (LTE-U) system, and a NR-based access to unlicensed spectrum (NR-U) system, a terrestrial networks (TN) system, a non-terrestrial networks (NTN) system, a wireless local area networks (WLAN), wireless fidelity (Wi-Fi), a cellular IoT system, and a cellular passive IoT system. The technical solutions may also be applied to a subsequent evolution system of a 5G NR system, and may also be applied to B5G, 6G and subsequent evolution systems. In some embodiments of the present application, “NR” may also be referred to as a 5G NR system or a 5G system. The 5G mobile communication system may include a non-standalone (NSA) and/or a standalone (SA).

The technical solutions provided in the embodiments of the present application may also be applied to machine type communication (MTC), long term evolution-machine (LTE-M) communication, device to device (D2D) network, machine to machine (M2M) network, Internet of Things (IoT) network, or other networks. The IoT network may include, for example, vehicle to everything network. The communication modes in the vehicle to everything system are collectively referred to as vehicle to other devices (Vehicle to X or V2X, where X may represent anything). For example, V2X may include vehicle to vehicle (V2V) communication, vehicle to infrastructure (V2I) communication, vehicle to pedestrian (V2P) communication, vehicle to network (V2N) communication or the like.

The wireless communication system provided in the present embodiment may be applied to, but is not limited to, at least one of the following communication scenarios: an uplink communication scenario, a downlink communication scenario or a sidelink communication scenario.

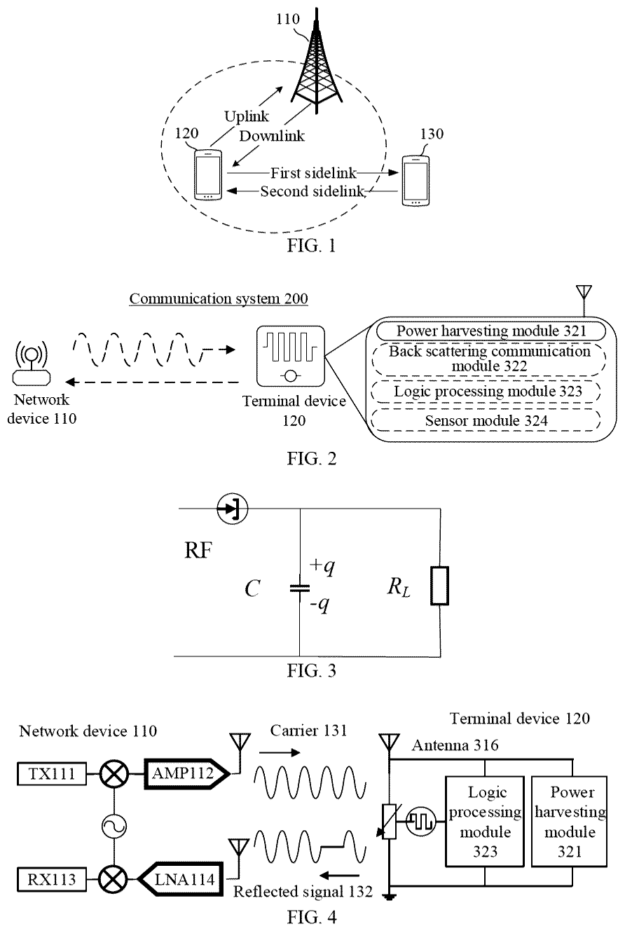

Taking the terminal device 120 as a zero-power device as an example, FIG. 2 illustrates a communication system 200 provided by an exemplary embodiment of the present application. The communication system 200 includes a network device 110 and a terminal device 120.

The terminal device 120 includes a power harvesting module 321. Optionally, in addition to the power harvesting module 321, the terminal device 120 also includes a back scattering communication module 322. Optionally, in addition to the power harvesting module 321, the terminal device 120 also includes a logic processing module 323, for example, the logic processing module 323 includes a low-power computing module. Optionally, in addition to the power harvesting module 321, the terminal device 120 may also include a sensor module 324. Optionally, in addition to the power harvesting module 321, the terminal device 120 also includes a memory (not illustrated in the figure). Optionally, in addition to the power harvesting module 321, the terminal device 120 may also include one or more of: a back scattering communication module 322, a logic processing module 323, a sensor module 324 and a memory.

For example, the power harvesting module 321 may harvest power carried by radio waves in space, or light power, or kinetic power, or mechanical power, solar power, or the like, so as to supply power to various modules for driving the terminal device 120. After obtaining power, the terminal device 120 may receive signals from the network device 110 through a receiver, or may reflect signals to the network device 110 through the back scattering communication module 322, or may transmit signals to the network device 110 through a transmitter (not illustrated in the figure). The data reflected or transmitted by the terminal device 120 may be its own stored data (e.g., identification or pre-written information, such as the production date, brand and manufacturer of the product). The sensor module 324 may include various types of sensors, and the terminal device 120 may report the data collected by various sensors based on a low-power mechanism. The memory is used to store some basic information (e.g., item identification) or to acquire sensor data such as ambient temperature and humidity.

The terminal device 120 may use the logic processing module 323 to implement simple operations such as signal demodulation, decoding, encoding and modulation. The hardware design may be very simple, making the terminal device 120 extremely low in cost and small in size.

It should be understood that modules included in the terminal device 120 illustrated in FIG. 2 are merely an example and not a limitation.

FIG. 3 illustrates a schematic diagram of radio frequency power harvesting performed by the power harvesting module 321. The radio frequency power harvesting is based on the principle of electromagnetic induction, utilizing a radio frequency module RF to connect through electromagnetic induction with a capacitor C and a load resistor RL connected in parallel, to enable harvesting electromagnetic power in space, and the power required to drive the zero-power device is obtained, such as for driving a low-power demodulation module, a modulation module, a sensor, and memory reading. Based on this, the effect of the zero-power device without traditional batteries is achieved.

FIG. 4 illustrates a schematic diagram of the back scattering communication module 322 performing back scattering communication. The terminal device 120 receives a wireless signal carrier 131 which is transmitted by a transmit module (TX) 111 of the network device 110 using an amplifier (AMP) 112, modulates the wireless signal carrier 131, loads information to be transmitted using the logic processing module 323, and harvests radio frequency power using the power harvesting module 321. The terminal device 120 uses an antenna 316 to radiate a modulated reflected signal 132, and the information transmission process is referred to as back scattering communication. A receive module (RX) 113 of the network device 110 receives the modulated reflected signal 132 using a low noise amplifier (LNA) 114. The back scattering and load modulation functions are inseparable. The load modulation adjusts and controls circuit parameters of the oscillation circuit of the terminal device 120 according to the rhythm of a data flow, to change parameters such as the impedance of the terminal device 120 and complete the modulation process.

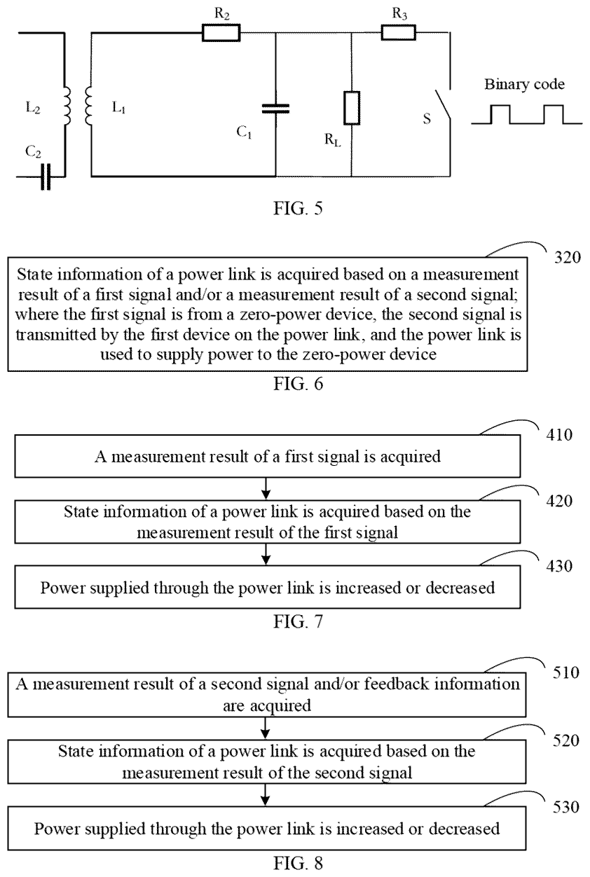

Load modulation techniques mainly include resistive load modulation and capacitive load modulation. FIG. 5 illustrates a schematic diagram of resistive load modulation. In resistive load modulation, the load resistor RL is connected in parallel with the third resistor R3, the switch S, controlled based on binary code, is used to turn the connection on or off, and the on or off of the third resistor R3 causes a change in circuit voltage. The load resistor RL is connected in parallel with the first capacitor C1, the load resistor RL is connected in series with the second resistor R2, and the second resistor R2 is connected in series with the first inductor L1. The first inductor L1 is coupled to the second inductor L2, and the second inductor L2 is connected in series with the second capacitor C2. For example, amplitude shift keying (ASK) may be implemented, that is, by adjusting an amplitude of a back scattering signal of the terminal device, the modulation and transmission of the signal are implemented. Similarly, in capacitive load modulation, the on or off of the capacitor may cause the resonant frequency of a circuit to be changed, thereby implementing frequency shift keying (FSK), that is, by adjusting the operating frequency of the back scattering signal of the zero-power device, the modulation and transmission of the signal are implemented.

The terminal device 120 may perform information modulation on an incoming wave signal by means of load modulation, to implement a back scattering communication process.

Optionally, the network device 110 may also include one or more of: a power harvesting module 321, a back scattering communication module 322, a logic processing module 323, a sensor module 324 and a memory.

Due to the significant advantages such as extremely low cost, extremely low power consumption and small size, the communication system illustrated in FIG. 2 may be widely used in various industries, such as logistics, smart warehousing, smart agriculture, power and electricity, industrial internet for vertical industries; and may also be applied in personal applications such as smart wearables and smart homes.

For example, the communication system may be applied to at least the following four types of scenarios:
(1) object recognition, such as logistics, production line product management and supply chain management;
(2) environmental monitoring, such as temperature, humidity and harmful gas monitoring of working environment and natural environment;
(3) positioning, such as indoor positioning, intelligent object search and production line item positioning; and
(4) intelligent control, such as intelligent control of various electrical appliances in smart homes (turning on and off air conditioners, adjusting temperature), and intelligent control of various facilities in agricultural greenhouses (automatic irrigation and fertilization).

The communication system illustrated in FIG. 2 may also meet the communication requirements of developing ultra-low cost, extremely small size, battery-free/maintenance-free cellular IoT, such as the harsh communication environments (e.g., extreme environments such as high temperature, extremely low temperature, high humidity, high pressure, high radiation or high speed movement) faced by IoT technologies such as narrowband-Internet of Things (NB-IoT), machine-type communications (MTC) and RedCap, the requirements for extremely small terminal form factors, and the requirements for extremely low cost IoT communication.

To complete communication, the zero-power device needs to perform some or all of the following tasks: power harvesting, power conversion, transmission, back scattering, sensing, computing and power storage.

Taking the harvested ambient power including radio frequency power as an example, the radio frequency power harvested by the zero-power device is from a power supply signal. The power supply signal refers to radio wave that supplies power to the zero-power device, or radio frequency that supplies power to the zero-power device. The transmitting end of the power supply signal may be the network device 110 as illustrated in FIG. 1 or FIG. 2, or the terminal device 130 as illustrated in FIG. 1.

The power source of the radio frequency power is radio frequency (RF). For example, the radio frequency power may be implemented using an antenna. For example, the power density of the radio frequency power is 0.1 to 10 μW/cm², or 0.001 (WiFi) to 0.1 (GSM) μW/cm². For example, the application environment of the radio frequency power is a (semi-) urban environment or a dedicated transmitter setup. For example, power conversion factors of the radio frequency power include: source transmission power, distance from source, antenna gain, and antenna design. For example, features of the radio frequency power are: partly controllable and partly predictable. For example, advantages of the radio frequency power include: ambient or dedicated techniques, high conversion efficiency, and availability anywhere. For example, disadvantages of the radio frequency power include: requires turning to frequency bands, energy availability limited by safety, distance dependent, and low-power density.

From the perspective of frequency band, the power supply signal may be a low-frequency signal, a medium-frequency signal, or a high-frequency signal.

From the perspective of waveform, the waveform of the power supply signal may be a sine wave, a square wave, a triangular wave, a pulse, or a rectangular wave. The waveform of the power supply signal may be continuous or discontinuous, that is, the power supply signal is allowed to be interrupted within a certain time domain range.

The power supply signal may be a signal dedicated to supplying power to the zero-power device, or may not be a signal dedicated to supplying power to the zero-power device. In other words, the power supply signal may carry data information, wake-up information, control information, system information, or the like.

For example, the channel carrying the power supply signal includes at least one of: a physical uplink shared channel (PUSCH), a physical uplink control channel (PUCCH), a physical downlink shared channel (PDSCH), a physical downlink control channel (PDCCH), a physical broadcast channel (PBCH), a physical random access channel (PRACH), a physical multicast channel (PMCH), a physical sidelink control channel (PSCCH), or a physical sidelink shared channel (PSSCH).

For example, the power supply signal includes at least one of: a control signal, a reference signal, a synchronization signal, a sensing signal, or an auxiliary signal.

For example, the reference signal includes at least one of: a positioning reference signal (PRS), a sidelink PRS (SL-PRS), a sounding reference signal (SRS), a demodulation reference signal (DMRS), an enhanced-SRS (E-SRS), a tracking reference signal (TRS), a carrier phase reference signal (CPRS), or a channel state information reference signal (CSI-RS).

However, there is no feasible solution for monitoring, feedback and adjustment related to the ambient power described above, which is not conducive to the efficiency and stability of the zero-power device utilizing ambient power for communication.

Therefore, the present application provides a method for acquiring link information, which provides a feasible solution for power-related monitoring, feedback and adjustment, and improves the efficiency and stability of zero-power communication.

In the embodiments of the present application, the “agreement” may be implemented by pre-storing corresponding codes, tables, mapping relationships or other means that may be used to indicate relevant information in a communication device (e.g., a terminal device, a network device, a zero-power device). The present application does not limit the specific implementation. Communication protocol agreement may also be understood as predefined by the communication protocol.

FIG. 6 illustrates a flowchart of a method for acquiring link information provided in an exemplary embodiment of the present application. The method is performed by a first device, and the method includes the following.

In step 320, state information of a power link is acquired based on a measurement result of a first signal and/or a measurement result of a second signal; where the first signal is from a zero-power device, the second signal is transmitted by the first device on the power link, and the power link is used to supply power to the zero-power device.

In the embodiments of the present application, the zero-power device is also referred to as a low-power device, an ultra-low-power device, a passive IoT device, or an ambient IoT/A-IoT device.

In some embodiments, a transmitting end of the first signal is the zero-power device, and a receiving end of the first signal is the first device and/or a second device.

In some embodiments, a transmitting end of the power link is the first device, and a receiving end of the power link is the zero-power device.

In some embodiments, a transmitting end of the second signal is the first device, and a receiving end of the second signal is the zero-power device.

In some embodiments, the power link is used to supply power to the zero-power device, and it may also be understood that a signal carried on the power link is used to supply power to the zero-power device. Therefore, the second signal transmitted on the power link is referred to as a power supply signal or a power signal.

In some embodiments, the first device is implemented as the network device 110, the terminal device 120, or the terminal device 130 described above. The first device is also referred to as a power supply device or a power supply node (Energizer).

In some embodiments, the second device is implemented as the network device 110, the terminal device 120, or the terminal device 130 described above. The second device is also referred to as a relay node.

In summary, according to the method provided in the embodiments of the present application, the first device is enabled to acquire the state information of the power link through the measurement results of the first signal and/or the second signal, thereby realizing the monitoring of the power link. This facilitates the first device to subsequently adjust the power supplied through the power link in a timely manner, and thus, the communication efficiency and stability of the zero-power device are ensured.

In some embodiments, the step 320 may be implemented as step 420 and/or step 520.

FIG. 7 illustrates a flowchart of a method for acquiring link information provided in an exemplary embodiment of the present application. The method is performed by a first device, and the method includes step 420. Optionally, in addition to step 420, the method may further include step 410 and/or step 430. The details are as follows.

In step 410, the measurement result of the first signal is acquired.

In some embodiments, the first signal is transmitted or backscattered by the zero-power device using power supplied through the power link.

In some embodiments, the first signal is transmitted and/or backscattered periodically by the zero-power device using power supplied through the power link.

In some embodiments, the first signal is transmitted and/or backscattered non-periodically by the zero-power device using power supplied through the power link.

In some embodiments, a transmission parameter of the first signal is configured by the first device or pre-configured by the first device, or agreed upon by a communication protocol, or determined by the zero-power device, or determined through negotiation between the first device and the zero-power device, or configured by the second device, or determined through negotiation between the first device and the second device, or determined through negotiation between the second device and the zero-power device.

In some embodiments, the transmission parameter of the first signal is indicated concurrently when the zero-power device reports its own capabilities.

In some embodiments, if the first signal is an uplink signal, the transmission parameter of the first signal is configured by the first device, or configured by the second device, or agreed upon by the communication protocol. If the first signal is a sidelink signal, the transmission parameter of the first signal is pre-configured by the first device, or pre-configured by the second device, or agreed upon by the communication protocol.

In some embodiments, the transmission parameter of the first signal includes at least one of:
a transmit power;
a transmission period;
a duration window;
a duty cycle;
a transmission capability level; or
a transmission capability index.

One transmission capability level corresponds to one mapping relationship, and the mapping relationship includes a mapping relationship between at least two transmission parameters.

One transmission capability index is used to indicate at least one parameter of a transmit power, a transmission period, a duration window or a duty cycle.

For example, the transmission parameter of the first signal is shown in Table 1. Each row, column and cell in Table 1 may be used separately or freely in combination. For example, the transmission parameter of the first signal may only include the first, second or third row. For example, the transmission parameter of the first signal may include only the first and second columns, or only the first and third columns. For example, when the transmission capability is 1, the transmit power is-30 dBm, and the period is 100 ms, 200 ms, 400 ms or others. Not all the free combinations are listed here, but it should be understood that the transmission parameters of the first signal are not limited to the design in Table 1.

TABLE 1
Transmission parameter of first signal

| Transmission | | | |
|---|---|---|---|
| capability | Transmission power | | |
| (Tx | (Tx power)/dBm | | |
| Capability) | (or converted to power/mW) | | Periodicity |
| 1 | −20 dBm | (10 uW) | 200 ms, 400 ms, or others |
| 2 | −30 dBm | (1 uW) | 100 ms, 200 ms, 400 ms, or |
| | | | others |
| 3 | −40 dBm | (0.1 uW) | 100 ms, 200 ms, 400 ms, or |

| | | |
|---|---|---|
| | | others |
| . . . | . . . | . . . |

In some embodiments, the measurement result of the first signal includes at least one of:
signal strength;
a first response time, including a startup time required for the zero-power device to transmit or backscatter the first signal for a first time; or
a second response time, including a transmission time interval between two adjacent first signals and/or an arrival time interval between two adjacent first signals.

Here, two adjacent first signals refer to two first signals that are adjacent in the time domain.

In some embodiments, a type of the first signal includes at least one of:
a sounding reference signal (SRS);
a demodulation reference signal (DMRS);
an enhanced-SRS (E-SRS);
a sidelink positioning reference signal (SL-PRS);
a sidelink broadcast signal;
a Bluetooth signal;
a Bluetooth low Energy (BLE) signal.

For example, the Bluetooth signal or the BLE signal includes a beacon signal.

In some embodiments, the measurement result of the first signal is determined by the first device. That is, the first device measures the first signal from the zero-power device and acquires the measurement result of the first signal.

In some embodiments, the measurement result of the first signal is determined by the second device. That is, the second device measures the first signal from the zero-power device, and the second device transmits the measurement result of the first signal to the first device.

In step 420, the state information of the power link is acquired based on the measurement result of the first signal.

In some embodiments, the state information of the power link is used to indicate that power supplied through the power link is lower than or equal to a first threshold, or that the power link is unstable. Optionally, the first threshold is configured by the first device or agreed upon by the communication protocol.

In some embodiments, the state information of the power link is used to indicate that power supplied through the power link is higher than or equal to a second threshold, or that the power link is stable. Optionally, the second threshold is configured by the first device or agreed upon by the communication protocol.

The power supplied through the power link includes at least one of: power that has already been supplied through the power link, power that is capable of being supplied through the power link, and power that will be supplied through the power link in the future.

The power that has already been supplied through the power link can be understood as the total power supplied through the power link before the measurement result of the first signal is acquired; or it may be understood as the power supplied through the power link during a first time period before the measurement result of the first signal is acquired. Optionally, the first time period is configured by the first device or agreed upon by the communication protocol.

The power that is capable of being supplied through the power link may be understood as the power that is supported to supply through the power link.

The power that will be supplied through the power link in the future may be understood as the total power that will be supplied through the power link after the measurement result of the first signal is acquired; or may be understood as the power that will be supplied through the power link during a second time period after the measurement result of the first signal is acquired. Optionally, the second time period is configured by the first device or agreed upon by the communication protocol.

In some embodiments, in a case where a signal strength of the first signal is lower than (or equal to) a third threshold, and/or a first response time of the first signal is later than (or equal to) a fourth threshold, and/or a second response time of the first signal is greater than (or equal to) a fifth threshold, it is determined that the state information of the power link indicates that the power supplied through the power link is lower than (or equal to) the first threshold, or indicates that the power link is unstable. Optionally, the third threshold is configured by the first device or agreed upon by the communication protocol. Optionally, the fourth threshold is configured by the first device or agreed upon by the communication protocol. Optionally, the fifth threshold is configured by the first device or agreed upon by the communication protocol.

In some embodiments, in a case where the signal strength of the first signal is higher than (or equal to) a sixth threshold, and/or the first response time of the first signal is earlier than (or equal to) a seventh threshold, and/or the second response time of the first signal is less than (or equal to) an eighth threshold, it is determined that the state information of the power link indicates that the power supplied through the power link is higher than (or equal to) the second threshold, or indicates that the power link is stable. Optionally, the sixth threshold is configured by the first device or agreed upon by the communication protocol. Optionally, the seventh threshold is configured by the first device or agreed upon by the communication protocol. Optionally, the eighth threshold is configured by the first device or agreed upon by the communication protocol.

In some embodiments, in a case where, for a period of time, the signal strength of the first signal is always lower than (or equal to) the third threshold, and/or the first response time of the first signal is always later than (or equal to) the fourth threshold, and/or the second response time of the first signal is always greater than (or equal to) the fifth threshold, it is determined that the state information of the power link indicates that the power supplied through the power link is lower than (or equal to) the first threshold, or indicates that the power link is unstable.

In some embodiments, in a case where, for a period of time, the signal strength of the first signal is always higher than (or equal to) the sixth threshold, and/or the first response time of the first signal is always earlier than (or equal to) the seventh threshold, and/or the second response time of the first signal is always less than (or equal to) the eighth threshold, it is determined that the state information of the power link indicates that the power supplied through the power link is higher than (or equal to) the second threshold, or indicates that the power link is stable.

It should be noted that various thresholds in the present application may be the same or different.

In step 430, the power supplied through the power link is increased or decreased.

In some cases, the power supply status of the power link needs to be adjusted. For example, when the power supplied through the power link is insufficient to maintain or trigger subsequent communication services, or when the zero-power device expects to harvest more power through the power link, or when the first device supports supplying more power to the zero-power device, the first device may perform some operations to increase the power supplied through the power link. For example, when the communication quality of zero-power communication is stable, or when the power supplied through the power link is too much, or when the zero-power device expects to save power, or when the power required by the zero-power device is less power than the power supplied through the power link, or when the first device expects to save power, the first device may perform some operations to decrease the power supplied through the power link.

In some embodiments, the first device increases or decreases the power supplied through the power link based on the state information of the power link.

In some embodiments, in a case where the state information of the power link indicates that the power supplied through the power link is lower than (or equal to) a first threshold, the first device increases the power supplied through the power link.

In some embodiments, in a case where the state information of the power link indicates that the power supplied through the power link is higher than (or equal to) a second threshold, the first device decreases the power supplied through the power link.

In some embodiments, in a case where the state information of the power link indicates that the power link is unstable, the first device increases the power supplied through the power link.

In some embodiments, in a case where the state information of the power link indicates that the power link is stable, the first device decreases the power supplied through the power link, or does not adjust the power supplied through the power link.

In some embodiments, the first device increases or decreases the power supplied through the power link based on request information from the zero-power device.

In some embodiments, the first device receives the request information from the zero-power device, and in a case where the request information is used to request an increase to the power supplied through the power link, the first device increases the power supplied through the power link.

In some embodiments, the first device receives the request information from the zero-power device, and in a case where the request information is used to request a decrease to the power supplied through the power link, the first device decreases the power supplied through the power link.

In some embodiments, the request information is carried in at least one of: a preamble, a protocol data unit (PDU), or a scheduling request (SR).

In some embodiments, increasing the power supplied through the power link includes at least one of the following manners:
increasing a transmit power of a signal carried by the power link;
increasing a number of signals carried by the power link;
increasing transmission frequency domain resources of a signal carried by the power link;
increasing transmission time domain resources of a signal carried by the power link;
increasing a duty cycle of a signal carried by the power link;
decreasing a transmission period of a signal carried by the power link;
increasing a duration (On Duration) (which is also referred to as an active time) corresponding to a discontinuous reception (DRX) state;
increasing a number of antennas corresponding to the power link;
transmitting a signal on the power link using a beamforming technique; or
transmitting a signal on the power link using a spatial diversity technique.

The transmission frequency domain resource is represented in at least one of the following forms: a carrier, a bandwidth part (BWP), a physical resource block (PRB), a subband, a subchannel, a subcarrier, or a frequency domain unit based on other frequency domain units.

In some embodiments, increasing the transmission frequency domain resources of the signal carried by the power link may also be understood as increasing the channel width corresponding to the power link. For example, the transmission frequency domain resources of the signal carried by the power link are increased by combining transmissions of multiple channels For example, the channel width corresponding to the power link is increased by Multi-Channel technology. For example, the transmission frequency domain resources of the signal carried by the power link are increased by resource block bundling (RB Bundling) technology.

The transmission time domain resource is represented in at least one of the following forms: a frame, a subframe, a slot, a mini-slot, a subslot, a symbol, a symbol group, or a time domain unit based on other time domain units.

For example, the transmission time domain resources of the signal carried by the power link are increased by combining transmissions of multiple slots. For example, the transmission time domain resources of the carried signal are increased by Multi-Slot technology. For example, the transmission time domain resources of the signal carried by the power link are increased by Slot Bundling technology.

Increasing the number of antennas corresponding to the power link, transmitting the signal on the power link using the beamforming technique and transmitting the signal on the power link using the spatial diversity technique may be considered as adjusting the antenna mode. Spatial diversity technology may be understood as multi-antenna transmit diversity, such as 2 transmit paths and antennas per frequency band (2Tx Per Band), 3 transmit paths and antennas per frequency band (3Tx Per Band), and 4 transmit paths and antennas per frequency band (4Tx Per Band).

In some embodiments, decreasing the power supplied through the power link includes at least one of the following manners:
decreasing a transmit power of a signal carried by the power link;
decreasing a number of signals carried by the power link;
decreasing transmission frequency domain resources of a signal carried by the power link;
decreasing transmission time domain resources of a signal carried by the power link;
decreasing a duty cycle of a signal carried by the power link;
increasing a transmission period of a signal carried by the power link;
decreasing a duration corresponding to a DRX state; or
decreasing a number of antennas corresponding to the power link.

It should be noted that steps 410 and 430 above are optional steps.

Each of the above steps may be implemented separately. For example, step 410 may be implemented separately as a signal measurement method, and step 430 may be implemented separately as a power adjustment method.

The above steps may be combined freely. For example, steps 410 and 420 may be combined to implement a method for monitoring a power link, or steps 410 and 430 may be combined to implement a method for adjusting a power link, or steps 420 and 430 may be combined to implement a method for monitoring and adjusting a power link, or steps 410, 420 and 430 may be combined to implement a method for monitoring and adjusting a power link.

In summary, according to the method provided in the embodiments of the present application, since the first signal is transmitted or backscattered by the zero-power device using the power supplied through the power link, the measurement result of the first signal may reflect the power supply status of the power link, thereby supporting the first device to acquire the state information of the power link and achieving the monitoring or maintenance of the power link by the first device.

Furthermore, the first device is enabled to actively increase or decrease the power supplied through the power link based on the state information of the power link, so that the proactive adjustments on the power link are implemented by the first device in a timely manner, the normal operation of the power link is ensured, and the efficiency and stability of the communication performed by the zero-power devices using the power supplied through the power link are ensured. The first device is also enabled to increase or decrease the power supplied through the power link based on the request of the zero-power device, so that the power supply status of the power link is more in line with the requirements or capabilities of the zero-power device and the resource utilization efficiency is improved.

By monitoring and adjusting the power link, it is helpful to ensure the requirements, efficiency and stability of power harvesting by the zero-power device, thereby ensuring the communication efficiency and stability of the zero-power device. Because the flexible adjustment of the power supplied through the power link is supported, it helps to ensure that the zero-power device meets different service requirements, and improves the flexibility and robustness of power harvesting and zero-power communication.

FIG. 8 illustrates a flowchart of a method for acquiring link information provided in an exemplary embodiment of the present application. The method is performed by a first device, and the method includes step 520. Optionally, in addition to step 520, the method may further include step 510 and/or step 530. The details are as follows.

In step 510, the measurement result of the second signal and/or feedback information are acquired.

In some embodiments, the second signal is transmitted by the first device on the power link. Optionally, the second signal is a periodically transmitted signal, or the second signal is a non-periodically transmitted signal.

In some embodiments, the transmission parameter of the second signal is configured by the first device, or agreed upon by the communication protocol, or determined by the zero-power device, or determined through negotiation between the first device and the zero-power device, or configured by the second device, or determined through negotiation between the first device and the second device, or determined through negotiation by the second device or the zero-power device.

In some embodiments, the second signal is referred to as a power supply signal or a power signal.

In some embodiments, the second signal has at least one of the following configurations:
supporting combining transmissions of multiple channels, such as supporting a Multi-Channel technique or a RB Bundling technique;
supporting combining transmissions of multiple slots, such as a Multi-Slot technique or a Slot Bundling technique;
periodic transmission, such as a period value of 1 ms, 2 ms, 4.5 ms, 15 ms;
non-periodic transmission;
a duration or a length of active time, such as 0.55 ms, 4.1 ms, 5 ms;
a proportion of duration or active time;
a duty cycle, values such as ⅛, ⅜, ⅝, 3/10, 4/8, 1/10;
modulation manner, such as one or more of: orthogonal frequency-division multiplexing (OFDM) modulation, quadrature phase shift keying (QPSK) modulation, amplitude shift keying (ASK) modulation, frequency shift keying (FSK) modulation, on-off keying (OOK) modulation, multi-carrier (MC-OOK) modulation, or quadrature amplitude modulation (QAM) modulation;
a coding manner, such as one or more of: not return to zero (NRZ) coding, Manchester coding, unipolar return to zero (URZ) coding, differential binary phase (DBP) coding, Miller coding, or differential coding;
supporting phase randomization;
supporting a high dynamic range (HDR) data transmission requirement;
supporting a low dynamic range (LDR) data transmission requirement;
a transmit power level, where the second signal may support one or more transmit power levels;
a supported antenna adjustment, such as dynamic antenna switching, changing antenna transmission direction, changing the number of antennas, and changing antenna polarization; or
a supported antenna mode, such as beamforming, beamforming training, transmit diversity, spatial diversity.

In some embodiments, the configuration of the second signal is referred to as a power transfer configuration, a power signal configuration, or a power signal characteristic.

In some embodiments, the configuration of the second signal is configured by the first device, or pre-configured by the first device, or agreed upon by the communication protocol, or determined by the zero-power device, or determined through negotiation between the first device and the zero-power device.

For example, the configuration of the second signal is shown in Table 2. Each row, column and cell in Table 2 may be used separately or freely in combination. For example, the configuration of the second signal may only include the first, second or third row. For example, the configuration of the second signal may include only the first and second columns, or only the first and third columns. For example, when the transmission capability is 1, the transmit power is 30 dBm, the duty cycle is ⅝, and the period is Ims, 2 ms, and 15 ms. Not all the free combinations are listed here, but it should be understood that the configuration of the second signal is not limited to the design in Table 2.

TABLE 2
Configuration of the second signal

| Tx | Tx power/dBm | | Duty | |
|---|---|---|---|---|
| Capability | (or converted to energy/mW) | | cycle | Periodicity |
| 1 | 33 dBm | (10 uW) | ⅛ | 1 ms, 2 ms, 15 ms, . . . |
| 2 | 30 dBm | (1 uW) | ⅜ | 1 ms, 2 ms, 15 ms, . . . |
| 3 | 27 dBm | (0.1 uW) | ⅝ | 1 ms, 2 ms, 15 ms, . . . |

| | | | |
|---|---|---|---|
| . . . | . . . | . . . | . . . |

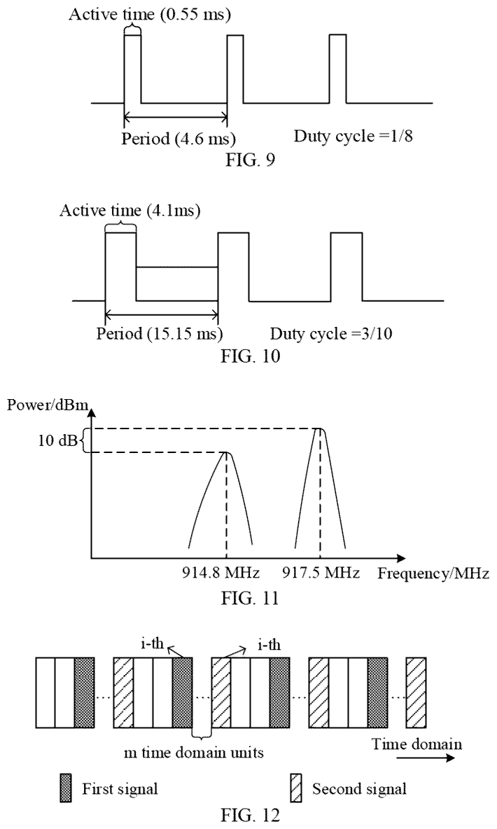

For example, when the duty cycle is ⅛, the period is 4.6 ms and the active time is 0.55 ms, as illustrated in FIG. 9. When the duty cycle is 3/10, the period is 15.15 ms and the active time is 4.1 ms, as illustrated in FIG. 10.

For example, as illustrated in FIG. 11, due to differences in one or more aspects such as duty cycle, transmission frequency and antenna gain, the transmit power corresponding to a center frequency of 914.8 MHz differs by 10 dB from the transmit power corresponding to a center frequency of 917.5 MHz.

In some embodiments, the transmit power of the second signal needs to meet the regulatory requirements of the first device, such as FCC or specific absorption rate (SAR) radiation requirements. For example, the power of per 3 kHz spectrum corresponding to the second signal cannot exceed 8 dBm. For example, the SAR value corresponding to the second signal is less than or equal to 1.6 W/kg. For example, the SAR value corresponding to the second signal is less than or equal to 2 W/kg.

In some embodiments, the measurement result of the second signal includes at least one of: a reference signal receiving power (RSRP) value; a reference signal strength indicator (RSSI) value; a reference signal receiving quality (RSRQ) value; a signal to interference plus noise ratio (SINR) value; a cross link interference (CLI) value; or a channel state information (CSI) value.

In some embodiments, the second signal is a signal dedicated to supply power to the zero-power device, or the second signal is not a signal dedicated to supply power to the zero-power device.

In some embodiments, the type of the second signal may include at least one of: a control signal; a reference signal; a synchronization signal; a sensing signal; an auxiliary signal; a wake-up signal; or a data signal.

In some embodiments, the reference signal includes at least one of: a PRS, an SL-PRS, an SRS, a DMRS, an enhanced-SRS, a TRS, a CPRS, or a CSI-RS.

In some embodiments, the channel carrying the second signal includes at least one of: a PUSCH, a PUCCH, a PDSCH, a PDCCH, a PBCH, a PRACH, a PMCH, a PSCCH, or a PSSCH.

In some embodiments, the measurement configuration of the second signal is configured by the first device or agreed upon by the communication protocol.

In some embodiments, the measurement configuration of the second signal includes at least one of:
a type of the second signal;
a measurement frequency point of the second signal;
a measurement time window of the second signal; or
a measurement period of the second signal.

In some embodiments, after acquiring the measurement result of the second signal and/or the feedback information determined based on the measurement result of the second signal, the first device may determine the state information of the power link, so as to realize the monitoring and maintenance of the power link. Therefore, the measurement configuration of the second signal may also be understood as the monitoring configuration of the power link or the power monitoring configuration.

In some embodiments, the first device transmits the monitoring configuration of the power link to the zero-power device and/or the second device, and the monitoring configuration includes at least one of the following parameters: a measurement object (e.g., the type of the second signal), a measurement frequency point (i.e., the measurement frequency point of the second signal), a duration of power monitoring, a monitoring period (e.g., the measurement period of the second signal), or a monitoring duration (e.g., the measurement time window of the second signal).

The duration of power monitoring is used to indicate the length of time during which the second signal is measured according to other parameters included in the monitoring configuration.

In some embodiments, the feedback information includes Acknowledgment (ACK) information and/or power sufficient information and/or a first value.

In some embodiments, in a case where the measurement result of the second signal is higher than or equal to a ninth threshold, the feedback information includes the ACK information and/or the power sufficient information and/or the first value. Optionally, the ninth threshold is configured by the first device or agreed upon by the communication protocol. Optionally, the first value includes “1” or “0” or other numerical values.

In some embodiments, the feedback information includes Negative Acknowledgement (NACK) information and/or power insufficient information and/or a second value.

In some embodiments, in a case where the measurement result of the second signal is lower than or equal to a tenth threshold, the feedback information includes the NACK information and/or the power insufficient information and/or the second value. Optionally, the tenth threshold is configured by the first device or agreed upon by the communication protocol. Optionally, the second value includes “0” or “1” or other numerical values. The second value is different from the first value.

In some embodiments, the measurement result of the second signal is determined by the second device and transmitted by the second device to the first device. That is, the second device measures the second signal from the first device and transmits the measurement result of the second signal to the first device, so that the first device acquires the measurement result of the second signal.

In some embodiments, the measurement result of the second signal is determined by the zero-power device and transmitted by the zero-power device to the first device. That is, the zero-power device measures the second signal from the first device and transmits the measurement result of the second signal to the first device, so that the first device acquires the measurement result of the second signal.

In some embodiments, the second device measures the second signal from the first device, determines the feedback information based on the measurement result of the second signal, and transmits the feedback information to the first device, so that the first device acquires the feedback information.

In some embodiments, the zero-power device measures the second signal from the first device, and the zero-power device transmits the measurement result of the second signal to the second device. The second device determines the feedback information based on the measurement results of the second signal, and transmits the feedback information to the first device, so that the first device acquires the feedback information.

In some embodiments, the zero-power device measures the second signal from the first device, determines the feedback information based on the measurement result of the second signal, and transmits the feedback information to the first device, so that the first device acquires the feedback information.

The feedback information may be understood as feedback information related to the power link, or feedback information related to the second signal.

In some embodiments, the first device receives the measurement result of the second signal from the second device, and/or the feedback information from the second device.

In some embodiments, the first device receives the measurement result of the second signal from the zero-power device, and/or the feedback information from the zero-power device.

In some embodiments, the first device receives the measurement result of the second signal from the second device, and/or the feedback information from the zero-power device.

In some embodiments, the first device receives the measurement result of the second signal from the zero-power device, and/or the feedback information from the second device.

In step 520, the state information of the power link is acquired based on the measurement result of the second signal.

In some embodiments, the first device acquires the state information of the power link based on the measurement result of the second signal.

In some embodiments, in a case where the measurement result of the second signal is higher than or equal to the ninth threshold, the first device determines that the state information of the power link indicates that the power supplied through the power link is higher than (or equal to) the second threshold.

In some embodiments, in a case where the measurement result of the second signal is lower than or equal to the tenth threshold, the first device determines that the state information of the power link indicates that the power supplied through the power link is lower than (or equal to) the first threshold.

In some embodiments, the first device acquires the state information of the power link based on the feedback information. The feedback information is determined based on the measurement result of the second signal.

In some embodiments, in a case where the feedback information includes the ACK information and/or the power sufficient information, the first device determines that the state information of the power link indicates that the power supplied through the power link is higher than (or equal to) the second threshold.

In some embodiments, in a case where the feedback information includes the NACK information and/or the power insufficient information, the first device determines that the state information of the power link indicates that the power supplied through the power link is lower than (or equal to) the first threshold.

The relevant content of the state information of the power link may refer to the description of step 420, which will not be repeated here.

In step 530, the power supplied through the power link is increased or decreased.

The relevant content may refer to the description of step 430, which will not be repeated here.

It should be noted that steps 510 and 530 above are optional steps.

Each of the above steps may be implemented separately. For example, step 510 may be implemented separately as a signal measurement method, and step 530 may be implemented separately as a power adjustment method.

The above steps may be combined freely. For example, steps 510 and 520 may be combined to implement a method for monitoring a power link, or steps 510 and 530 may be combined to implement a method for adjusting a power link, or steps 520 and 530 may be combined to implement a method for monitoring and adjusting a power link, or steps 510, 520 and 530 may be combined to implement a method for monitoring and adjusting a power link.

In summary, according to the method provided in the embodiments of the present application, since the second signal is a signal transmitted on the power link, the measurement result of the second signal may reflect the power supply status of the power link, thereby supporting the first device to acquire the state information of the power link and realizing the monitoring or maintenance of the power link by the first device.

Furthermore, the first device is enabled to actively increase or decrease the power supplied through the power link based on the state information of the power link, so that the proactive adjustments on the power link are implemented by the first device in a timely manner, the normal operation of the power link is ensured, and the efficiency and stability of the communication performed by the zero-power devices using the power supplied through the power link are ensured. The first device is also enabled to increase or decrease the power supplied through the power link based on the request of the zero-power device, so that the power supply status of the power link is more in line with the requirements or capabilities of the zero-power device and the resource utilization efficiency is improved.

In some embodiments, the embodiments illustrated in FIG. 7 and FIG. 8 may be used in combination, that is, the first device acquires the state information of the power link based on the measurement result of the first signal and the measurement result of the second signal. This approach helps the first device not only to clarify the transmission status of the power supply signal, but also to clarify the communication state of the zero-power device, so that the determined state information of the power link is more accurate and consistent with the actual situations, and the monitoring and maintenance of the power link are further ensured.

In some embodiments, the transmission period of the first signal is the same as the transmission period of the second signal, or the transmission period of the first signal and the transmission period of the second signal are in one-to-one correspondence. For example, as illustrated in FIG. 12, both the second signal and the first signal are transmitted periodically, and the transmission time domain resource of the i-th first signal is spaced m time domain units apart from the transmission time domain resource of the i-th second signal, where m is greater than or equal to 0.

In some embodiments, the transmission period of the first signal is different from the transmission period of the second signal. For example, both the second signal and the first signal are transmitted periodically, and the transmission period of the first signal is greater than or less than the transmission period of the second signal. For example, the second signal is transmitted periodically, while the first signal is transmitted non-periodically. For example, the second signal is transmitted non-periodically, while the first signal is transmitted periodically.

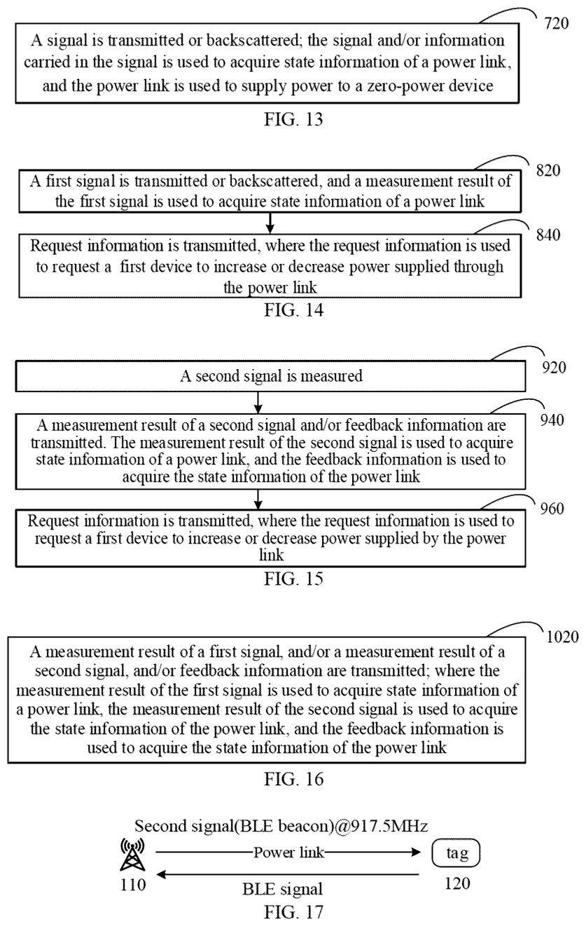

FIG. 13 illustrates a flowchart of a method for acquiring link information provided in an exemplary embodiment of the present application. This method is performed by a zero-power device, and the method includes the following.

In step 720, a signal is transmitted or backscattered; the signal and/or information carried in the signal is used to acquire state information of a power link, and the power link is used to supply power to the zero-power device.

In some embodiments, the zero-power device transmits a first signal or backscatters a first signal. A measurement result of the first signal is used to acquire the state information of the power link.

In some embodiments, the zero-power device transmits a measurement result of a second signal and/or transmits feedback information. The measurement result of the second signal is used to acquire the state information of the power link, and the feedback information is used to acquire the state information of the power link.

In the embodiments of the present application, the zero-power device is also referred to as a low-power device, an ultra-low-power device, a passive IoT device, or an A-IoT device.

In some embodiments, a receiving end of the first signal is a first device and/or a second device.

In some embodiments, a transmitting end of the power link is the first device, and the receiver of the power link is the zero-power device.

In some embodiments, a transmitting end of the second signal is the first device, and a receiving end of the second signal is the zero-power device.

In some embodiments, the power link is used to supply power to the zero-power device, and it may also be understood that a signal carried on the power link is used to supply power to the zero-power device. Therefore, the second signal transmitted on the power link is referred to as a power supply signal or a power signal.

In some embodiments, the first device is implemented as the network device 110, the terminal device 120, or the terminal device 130 described above. The first device is also referred to as a power supply device or a power supply node (Energizer).

In some embodiments, the second device is implemented as the network device 110, the terminal device 120, or the terminal device 130 described above. The second device is also referred to as a relay node.

In summary, according to the method provided in the embodiments of the present application, the zero-power device is enabled to reflect or transmit the first signal to enable the first device to acquire the state information of the power link, and is also enabled to transmit the measurement result of the second signal and the feedback information to enable the first device to acquire the state information of the power link. Through the participation of the zero-power device, the monitoring of the power link is achieved, thereby facilitating subsequent adjustment of the power supplied through the power link by the first device in a timely manner, and further ensuring the communication efficiency and stability of the zero-power device.

In some embodiments, step 720 may be implemented as step 820 and/or step 940.

FIG. 14 illustrates a flowchart of a method for acquiring link information provided in an exemplary embodiment of the present application. The method is performed by a zero-power device and includes step 820. Optionally, in addition to step 820, the method further includes step 840. The details are as follows.

In step 820, the first signal is transmitted or backscattered, and the measurement result of the first signal is used to acquire the state information of the power link.

In some embodiments, the first signal is transmitted or backscattered by the zero-power device using power supplied through the power link.

In some embodiments, the first signal is periodically transmitted and/or backscattered by the zero-power device using power supplied through the power link.

In some embodiments, the first signal is non-periodically transmitted and/or backscattered by the zero-power device using power supplied through the power link.

In some embodiments, the transmission parameter of the first signal is configured by the first device, or agreed upon by a communication protocol, or determined by the zero-power device, or determined through negotiation between the first device and the zero-power device, or configured by the second device, or determined through negotiation between the first device and the second device, or determined through negotiation by the second device or the zero-power device.

In some embodiments, if the first signal is an uplink signal, the transmission parameter of the first signal is configured by the first device, or configured by the second device, or agreed upon by the communication protocol. If the first signal is a sidelink signal, the transmission parameter of the first signal is pre-configured by the first device, or pre-configured by the second device, or agreed upon by the communication protocol.

In some embodiments, the transmission parameter of the first signal includes at least one of: a transmit power; a transmission period; a duration window; a duty cycle; a transmission capability level; or a transmission capability index.

In some embodiments, the measurement result of the first signal includes at least one of: a signal strength; a first response time; or a second response time.

In some embodiments, a type of the first signal may include at least one of: an SRS; a DMRS; an enhanced-SRS; an SL-PRS; a sidelink broadcast signal; or a Bluetooth beacon signal.

In some embodiments, the measurement result of the first signal is determined by the first device. That is, the first device measures the first signal from the zero-power device and acquires the measurement result of the first signal.

In some embodiments, the measurement result of the first signal is determined by the second device. That is, the second device measures the first signal from the zero-power device, and the second device transmits the measurement result of the first signal to the first device.

The relevant content may refer to the description of step 410, which will not be repeated here.

In step 840, request information is transmitted, where the request information is used to request the first device to increase or decrease power supplied through the power link.

In some cases, the zero-power device expects or requires the power supply status of the power link to be adjusted. For example, in a case where the power supplied through the power link is insufficient to maintain or trigger subsequent communication services, or in a case where the zero-power device expects to harvest more power through the power link, the zero-power device may transmit the request information for requesting the first device to increase the power supplied through the power link. For example, in a case where the communication quality of zero-power communication is stable, or in a case where the power supplied through the power link is too much or in a case where the zero-power device expects to save power, or in a case where the zero-power device requires less power than the power supplied through the power link, the zero-power device may transmit the request information for requesting the first device to decrease the power supplied through the power link.

In some embodiments, the zero-power device transmits the request information to the first device. Alternatively, the zero-power device transmits the request information to the second device, and the second device transmits the request information to the first device.

The relevant content of the request information may refer to the description of step 430, which will not be repeated here.

It should be noted that step 840 above is an optional step.

Each of the above steps may be implemented separately. For example, step 820 may be implemented separately as a signal measurement method, and step 840 may be implemented separately as a power adjustment method. The above steps may be combined into one step, for example, the zero-power device may carry the request information in the first signal.

The execution order of the above steps may be adjusted according to the actual situations. For example, step 840 may be performed prior to step 820.

In summary, according to the method provided in the embodiments of the present application, the zero-power device is enabled to reflect or transmit the first signal to enable the first device to acquire the state information of the power link. Since the first signal is transmitted or backscattered by the zero-power device using the power supplied through the power link, through the participation of the zero-power device, the monitoring of the power link is achieved, thereby facilitating subsequent adjustment of the power supplied through the power link by the first device in a timely manner, and further ensuring the communication efficiency and stability of the zero-power device.

FIG. 15 illustrates a flowchart of a method for acquiring link information provided in an exemplary embodiment of the present application. The method is performed by a zero-power device and includes step 940. Optionally, in addition to step 940, the method may further include step 920 and/or step 960. The details are as follows.

In step 920, a second signal is measured.

The relevant content of the second signal may refer to the description of step 510, which will not be repeated here.

In some embodiments, the measurement configuration of the second signal is configured by the first device or agreed upon by the communication protocol.

In some embodiments, the measurement configuration of the second signal includes at least one of: a type of the second signal; a measurement frequency point of the second signal; a measurement time window of the second signal; or a measurement period of the second signal.

In some embodiments, the first device transmits the monitoring configuration of the power link to the zero-power device and/or the second device, and the monitoring configuration includes at least one of the following parameters: a measurement object (e.g., the type of the second signal), a measurement frequency point (i.e., the measurement frequency point of the second signal), a duration of power monitoring, a monitoring period (e.g., the measurement period of the second signal), or a monitoring duration (e.g., the measurement time window of the second signal).

In some embodiments, the zero-power device generates the feedback information based on the measurement result of the second signal. The relevant content of the feedback information may refer to the description of step 510, which will not be repeated here.

In some embodiments, the measurement of the second signal has no effect on data reception, and the zero-power device measures the second signal without interrupting the reception of data, or the zero-power device receives data without interrupting the measurement of the second signal.

In some embodiments, the measurement of the second signal by the zero-power device may refer to the process of Radio Link Monitor or the process of Listen Before Talk in related art, to realize periodic measurement of the second signal and/or periodic reporting of the measurement result of the second signal. Optionally, the period for measuring the second signal may be the same as or different from the period for reporting the measurement result of the second signal.

In step 940, the measurement result of the second signal and/or feedback information are transmitted. The measurement result of the second signal is used to acquire the state information of the power link, and the feedback information is used to acquire the state information of the power link.

The relevant content of the second signal and the feedback information may refer to the description of step 510, which will not be repeated here.

In some embodiments, the zero-power device determines the measurement result of the second signal and transmits the measurement result of the second signal to the first device or the second device.

In some embodiments, the zero-power device determines the measurement result of the second signal, generates the feedback information based on the measurement result of the second signal, and transmits the feedback information to the first device or the second device.

In step 960, the request information is transmitted, where the request information is used to request the first device to increase or decrease power supplied by the power link.

In some cases, the zero-power device expects or requires the power supply status of the power link to be adjusted. For example, in a case where the power supplied through the power link is insufficient to maintain or trigger subsequent communication services, or in a case where the zero-power device expects to harvest more power through the power link, the zero-power device may transmit the request information for requesting the first device to increase the power supplied through the power link. For example, in a case where the communication quality of zero-power communication is stable, or in a case where the power supplied through the power link is too much or in a case where the zero-power device expects to save power, or in a case where the zero-power device requires less power than the power supplied through the power link, the zero-power device may transmit the request information for requesting the first device to decrease the power supplied through the power link.

In some embodiments, the zero-power device transmits the request information to the first device. Alternatively, the zero-power device transmits the request information to the second device, and the second device transmits the request information to the first device.

The relevant content of the requested information may refer to the description of step 430, which will not be repeated here.

It should be noted that steps 920 and 960 above are optional steps.

The above steps may be combined freely or performed separately. For example, step 920 may be implemented separately as a signal measurement method. For example, step 960 may be implemented separately as a power adjustment method. For example, steps 920 and 940 may be combined to implement a signal measurement method. For example, steps 940 and 960 may be combined to implement a power adjustment method. For example, steps 940 and 960 may be combined into one step, meaning that the zero-power device carries the request information in the measurement result of the second signal, or carries the feedback information and the request information in the same signal.

The execution order of the above steps may be adjusted according to the actual situations. For example, step 960 may be performed prior to step 920, or step 960 may be performed prior to step 940.

In summary, according to the method provided in the embodiments of the present application, the zero-power device is enabled to reflect or transmit the first signal to enable the first device to acquire the state information of the power link. Since the first signal is transmitted or backscattered by the zero-power device using the power supplied through the power link, through the participation of the zero-power device, the monitoring of the power link is achieved, thereby facilitating subsequent adjustment of the power supplied through the power link by the first device in a timely manner, and further ensuring the communication efficiency and stability of the zero-power device.

FIG. 16 illustrates a flowchart of a method for acquiring link information provided in an exemplary embodiment of the present application. The method is performed by a second device, and the method includes the following.

In step 1020, a measurement result of a first signal, and/or a measurement result of a second signal, and/or feedback information are transmitted; where the measurement result of the first signal is used to acquire state information of a power link, the measurement result of the second signal is used to acquire the state information of the power link, and the feedback information is used to acquire the state information of the power link.

In some embodiments, the second device is implemented as the network device 110, the terminal device 120, or the terminal device 130 described above. The second device is also referred to as a relay node.

In some embodiments, a transmitting end of the first signal is a zero-power device, and a receiving end of the first signal is a first device and/or a second device.

In some embodiments, a transmitting end of the power link is the first device, and a receiving end of the power link is the zero-power device.

In some embodiments, a transmitting end of the second signal is the first device, and a receiving end of the second signal is the zero-power device.

In some embodiments, the power link is used to supply power to the zero-power device, and it may also be understood that a signal carried on the power link is used to supply power to the zero-power device. Therefore, the second signal transmitted on the power link is referred to as a power supply signal or a power signal.

In some embodiments, the first device is implemented as the network device 110, the terminal device 120, or the terminal device 130 described above. The first device is also referred to as a power supply device or a power supply node (Energizer).

In the embodiments of the present application, the zero-power device is also referred to as a low-power device, an ultra-low-power device, a passive IoT device, or an A-IoT device.

In some embodiments, the second device measures the first signal and transmits the measurement result of the first signal to the first device. The relevant content of the first signal and its measurement configuration may refer to the description of step 410.

In some embodiments, the second device measures the second signal and transmits the measurement result of the second signal to the first device. Alternatively, the second device generates feedback information based on the measurement result of the second signal and transmits the feedback information to the first device.

In some embodiments, the zero-power device transmits the measurement result of the second signal to the second device, and the second device forwards the measurement result of the second signal to the first device. Alternatively, the second device generates the feedback information based on the measurement result of the second signal and transmits the feedback information to the first device.

In some embodiments, the zero-power device acquires the measurement result of the second signal and generates the feedback information based on the measurement result of the second signal. The zero-power device transmits the feedback information to the second device, and the second device forwards the feedback information to the first device.

The relevant content of the second signal, its measurement configuration and feedback information may be referred to the description of step 510.

In summary, according to the method provided in the embodiments of the present application, the second device is enabled to feed back one or more of the measurement result of the first signal, the measurement result of the second signal and the feedback information to the first device, so that the first device acquires the state information of the power link. Through the participation of the second device, the monitoring of the power link is achieved, thereby facilitating subsequent adjustment of the power supplied through the power link by the first device in a timely manner, and further ensuring the communication efficiency and stability of the zero-power device.

FIG. 17 illustrates a schematic diagram of a method for acquiring link information provided in an exemplary embodiment of the present application, and the method is implemented by a power supply node (e.g., the network device 110) and a zero-power device (e.g., the terminal device 120). For example, the terminal device 120 is an electronic tag.

The number of power supply nodes is one or more. The number of zero-power devices is one or more. FIG. 17 takes one power supply node and one zero-power device as an example, but this does not mean that the numbers of power supply nodes and zero-power devices are limited thereto.

The power link is a downlink from the network device 110 to the terminal device 120. The network device 110 transmits a second signal on the power link to supply power to the terminal device 120. For example, the second signal includes a BLE beacon signal. For example, the center frequency of the second signal is 917.5 MHz.

Optionally, the network device 110 transmits measurement configuration of the second signal to the terminal device 120. The terminal device 120 measures the second signal based on the measurement configuration and acquires the measurement result of the second signal. The terminal device 120 transmits the measurement result of the second signal to the network device 110. For example, the terminal device 120 transmits or backscatters a BLE signal to the network device 110, and the BLE signal carries the measurement result of the second signal.

Optionally, the network device 110 acquires the state information of the power link based on the received measurement result of the second signal.

Optionally, after acquiring the measurement result of the second signal, the terminal device 120 generates feedback information and transmits the feedback information to the network device 110. For example, the terminal device 120 generates the feedback information indicating whether the power is sufficient based on the measurement result of the second signal, and transmits the feedback information to the network device 110.

Optionally, the network device 110 acquires the state information of the power link based on the received feedback information.

Optionally, the network device 110 configures or pre-configures a transmission parameter of the first signal to the terminal device 120. The terminal device 120 transmits or backscatters the first signal based on the transmission parameter. The network device 110 measures the first signal and acquires the measurement result of the first signal. For example, the terminal device 120 transmits or backscatters the BLE signal to the network device 110 based on the configured transmission parameter, and the network device 110 measures the BLE signal and acquires a measurement result of the BLE signal.

Optionally, the network device 110 acquires the state information of the power link based on the measurement result of the first signal.

Optionally, the terminal device 120 transmits request information to the network device 110, where the request information is used to request the network device 110 to increase or decrease the power supplied through the power link.

Optionally, the network device 110 adjusts the power supplied through the power link based on the state information of the power link and/or the request information from the terminal device 120.

For example, the state information of the power link indicates that the power supplied through the power link is lower than or equal to a first threshold, and the network device 110 increases the power supplied through the power link. For example, the state information of the power link indicates that the power supplied through the power link is higher than or equal to a second threshold, and the network device 110 decreases the power supplied through the power link.

For example, the request information is used to request an increase to the power supplied through the power link, and the network device 110 increases the power supplied through the power link. For example, the request information is used to request a decrease to the power supplied through the power link, and the network device 110 decreases the power supplied through the power link.

For example, the network device 110 achieves the effect of increasing the power supplied through the power link by one or more of the following operations: increasing a center frequency of the second signal, decreasing a transmission period of the second signal, increasing a number of second signals, increasing frequency domain resources occupied by the second signal, increasing time domain resources occupied by the second signal, increasing a duty cycle of the second signal, or increasing a number of antennas transmitting the second signal.

For example, the network device 110 achieves the effect of decreasing the power supplied through the power link by one or more of the following operations: decreasing a center frequency of the second signal, increasing a transmission period of the second signal, decreasing a number of second signals, decreasing frequency domain resources occupied by the second signal, decreasing time domain resources occupied by the second signal, decreasing a duty cycle of the second signal, decreasing a number of antennas transmitting the second signal, or decreasing a spatial diversity capability.

For example, the terminal device 120 backscatters the BLE signal to the network device 110 based on the configured transmission parameter. The network device 110 measures the BLE signal and acquires the measurement result of the BLE signal. The measurement result shows that, within a certain period of time (e.g., 3 seconds), the second response time of the BLE signal is always equal to or less than a fifth threshold. Then, the network device 110 determines that the power link is stable or that the power supplied through the power link is higher than the first threshold. The network device 110 may appropriately decrease the transmission period or transmit power of the second signal, or enter the DTX state. After the power supplied through the power link is decreased, the monitoring or feedback related to the power link is continued to be performed.

For example, the terminal device 120 expects to transmit a HDR data service, and transmits the request information to the network device 110 to request an increase to the power supplied through the power link. After receiving the request information, the network device 110 increases the transmit power of the second signal or adopts a Multi-Slot combining transmission manner to increase the power of the power link.

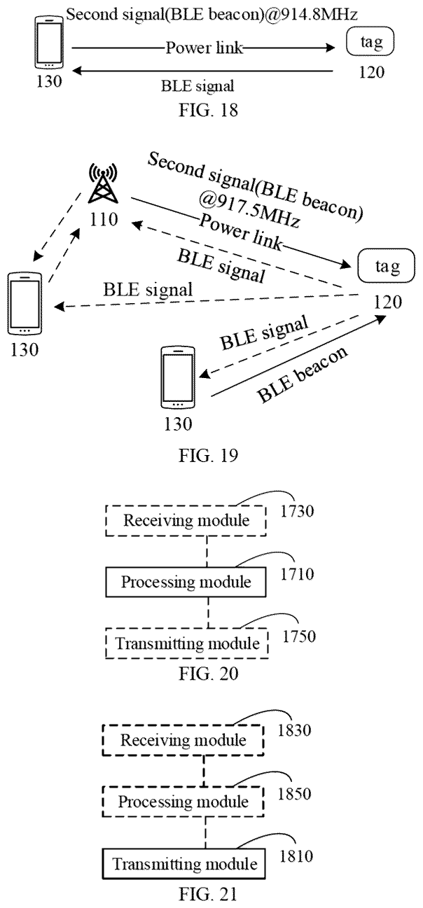

FIG. 18 illustrates a schematic diagram of a method for acquiring link information provided in an exemplary embodiment of the present application, and the method is implemented by a power supply node (e.g., the terminal device 130) and a zero-power device (e.g., the terminal device 120). For example, the terminal device 120 is an electronic tag, and the terminal device 130 is a mobile phone.

The number of power supply nodes is one or more. The number of zero-power devices is one or more. FIG. 18 takes one power supply node and one zero-power device as an example, but this does not mean that the numbers of power supply nodes and zero-power devices are limited thereto.

The power link is a sidelink from the terminal device 130 to the terminal device 120. The terminal device 130 transmits a second signal on the power link to supply power to the terminal device 120.

For example, the second signal is a broadcast signal or a multicast signal or a unicast signal. For example, the second signal is transmitted on a Bluetooth channel, for example, the channel number is any one or more numbers from 0 to 39. For example, the second signal includes a BLE beacon signal. For example, the center frequency of the second signal is 914.8 MHz.

Optionally, the network device 110 or the terminal device 130 transmits a measurement configuration of the second signal to the terminal device 120. The terminal device 120 measures the second signal based on the measurement configuration and acquires the measurement result of the second signal. The terminal device 120 transmits the measurement result of the second signal to the terminal device 130. For example, the terminal device 120 transmits or backscatters a BLE signal to the terminal device 130 on a Bluetooth channel, and the BLE signal carries the measurement result of the second signal.

Optionally, the terminal device 130 acquires the state information of the power link based on the received measurement result of the second signal.

Optionally, after acquiring the measurement result of the second signal, the terminal device 120 generates feedback information and transmits the feedback information to the terminal device 130. For example, the terminal device 120 generates the feedback information indicating whether the power is sufficient based on the measurement result of the second signal, and transmits the feedback information to the terminal device 130.

Optionally, the terminal device 130 acquires the state information of the power link based on the received feedback information.

Optionally, the network device 110 pre-configures a transmission parameter of the first signal to the terminal device 120, and the terminal device 120 transmits or backscatters the first signal based on the pre-configured transmission parameter.

Optionally, the terminal device 130 configures the transmission parameter of the first signal to the terminal device 120, and the terminal device 120 transmits or backscatters the first signal based on the configured transmission parameter.

Optionally, the terminal device 130 measures the first signal and acquires the measurement result of the first signal. For example, the terminal device 120 transmits or backscatters the BLE signal to the terminal device 130 based on the pre-configured transmission parameter, and the terminal device 130 measures the BLE signal and acquires the measurement result of the BLE signal.

Optionally, the terminal device 130 acquires the state information of the power link based on the measurement result of the first signal.

Optionally, the terminal device 120 transmits request information to the terminal device 130, where the request information is used to request the terminal device 130 to increase or decrease the power supplied through the power link.

The terminal device 130 adjusts the power supplied through the power link based on the state information of the power link and/or the request information from the terminal device 120.

For example, the state information of the power link indicates that the power supplied through the power link is lower than or equal to a first threshold, and the terminal device 130 increases the power supplied through the power link. For example, the state information of the power link indicates that the power supplied through the power link is higher than or equal to a second threshold, and the terminal device 130 decreases the power supplied through the power link.

For example, the request information is used to request an increase to the power supplied through the power link, and the terminal device 130 increases the power supplied through the power link. For example, the request information is used to request a decrease to the power supplied through the power link, and the terminal device 130 decreases the power supplied through the power link.

For example, the terminal device 130 achieves the effect of increasing the power supplied through the power link by one or more of the following operations: increasing a center frequency of the second signal, decreasing a transmission period of the second signal, increasing a number of second signals, increasing frequency domain resources occupied by the second signal, increasing time domain resources occupied by the second signal, increasing a duty cycle of the second signal, or increasing a number of antennas transmitting the second signal.

For example, the terminal device 130 achieves the effect of decreasing the power supplied through the power link by one or more of the following operations: decreasing a center frequency of the second signal, increasing a transmission period of the second signal, decreasing a number of second signals, decreasing frequency domain resources occupied by the second signal, decreasing time domain resources occupied by the second signal, decreasing a duty cycle of the second signal, decreasing a number of antennas transmitting the second signal, or decreasing a spatial diversity capability.

For example, the terminal device 120 backscatters the BLE signal to the terminal device 130 based on the pre-configured transmission parameter. The terminal device 130 measures the BLE signal and acquires the measurement result of the BLE signal. The measurement result shows that the second response time of the BLE signal is equal to or less than a fifth threshold (e.g., 200 ms), and that the second response time of the BLE signal is always less than or equal to the fifth threshold for a period of time (e.g., 5s). Then, the terminal device 130 determines that the power link is stable or that the power supplied through the power link is higher than the first threshold. The terminal device 130 decreases the power supplied through the power link, or does not change the power supplied through the power link.

FIG. 19 illustrates a schematic diagram of a method for acquiring link information provided by an exemplary embodiment of the present application. The method is implemented by a power supply node (e.g., the network device 110 or terminal device 130, where the power supply node is taken as the network device 110 as an example in the embodiments of the present application), a relay node (e.g., the network device 110 or terminal device 130, where the relay node is taken as the terminal device 130 as an example in the embodiments of the present application), and a zero-power device (e.g., the terminal device 120). For example, the terminal device 120 is an electronic tag, and the terminal device 130 is a mobile phone.

The number of power supply nodes is one or more. The number of relay nodes is one or more. The number of zero-power devices is one or more. FIG. 19 takes one power supply node, two relay nodes and one zero-power device as an example, but this does not mean that the numbers of power supply nodes, relay nodes and zero-power devices are limited thereto.

The power link is a downlink from the network device 110 to the terminal device 120. The network device 110 transmits a second signal on the power link to supply power to the terminal device 120. For example, the second signal includes a BLE beacon signal. For example, the center frequency of the second signal is 917.5 MHz.

Optionally, the network device 110 transmits measurement configuration of the second signal to the terminal device 120 and/or the terminal device 130.

Optionally, the terminal device 120 measures the second signal based on the measurement configuration and acquires the measurement result of the second signal. The terminal device 120 transmits the measurement result of the second signal to the network device 110 and/or the terminal device 130. For example, the terminal device 120 transmits or backscatters a BLE signal to the network device 110 and/or the terminal device 130, and the BLE signal carries the measurement result of the second signal.

Optionally, the terminal device 130 measures the second signal based on the measurement configuration and acquires the measurement result of the second signal. The terminal device 130 transmits the measurement result of the second signal to the network device 110. For example, the terminal device 130 transmits or backscatters the BLE signal to the network device 110, and the BLE signal carries the measurement result of the second signal.

Optionally, the network device 110 acquires the state information of the power link based on the received measurement result of the second signal.

Optionally, the terminal device 120 and/or the terminal device 130 generate feedback information based on the measurement result of the second signal and transmit the feedback information to the network device 110.

Optionally, the network device 110 acquires the state information of the power link based on the received feedback information.

Optionally, the network device 110 configures or pre-configures the transmission parameter of the first signal to the terminal device 120. The terminal device 120 transmits or backscatters the first signal based on the transmission parameter.

Optionally, the network device 110 measures the first signal and acquires the measurement result of the first signal.

Optionally, the terminal device 130 measures the first signal and acquires the measurement result of the first signal. For example, the terminal device 120 transmits or backscatters the BLE signal to the terminal device 130 based on the pre-configured transmission parameter. The terminal device 130 measures the BLE signal, acquires the measurement result of the BLE signal, and transmits the measurement result of the BLE signal to the network device 110.

Optionally, the network device 110 acquires the state information of the power link based on the measurement result of the first signal.

Optionally, the terminal device 120 transmits request information to the network device 110. Alternatively, the terminal device 120 transmits the request information to the terminal device 130, and the terminal device 130 forwards the request information to the network device 110. The request information is used to request the network device 110 to increase or decrease the power supplied through the power link.

The network device 110 adjusts the power supplied through the power link based on the state information of the power link and/or request information.

For example, the state information of the power link indicates that the power supplied through the power link is lower than or equal to a first threshold, the network device 110 increases the power supplied through the power link. For example, the state information of the power link indicates that the power supplied through the power link is higher than or equal to a second threshold, the network device 110 decreases the power supplied through the power link.

For example, the request information is used to request an increase to the power supplied through the power link, and the network device 110 increases the power supplied through the power link. For example, the request information is used to request a decrease to the power supplied through the power link, and the network device 110 decreases the power supplied through the power link.

For example, the network device 110 achieves the effect of increasing the power supplied through the power link by one or more of the following operations: increasing a center frequency of the second signal, decreasing a transmission period of the second signal, increasing a number of second signals, increasing frequency domain resources occupied by the second signal, increasing time domain resources occupied by the second signal, increasing a duty cycle of the second signal, or increasing a number of antennas transmitting the second signal.

For example, the network device 110 achieves the effect of decreasing the power supplied through the power link by one or more of the following operations: decreasing a center frequency of the second signal, increasing a transmission period of the second signal, decreasing a number of second signals, decreasing frequency domain resources occupied by the second signal, decreasing time domain resources occupied by the second signal, decreasing a duty cycle of the second signal, decreasing a number of antennas transmitting the second signal, or decreasing a spatial diversity capability.

For example, the terminal device 120 backscatters the BLE signal to the network device 110 or the terminal device 130 based on the configured transmission parameter. The network device 110 or the terminal device 130 measures the BLE signal and acquires the measurement result of the BLE signal. The measurement result shows that the second response time of the BLE signal (e.g., 500 ms) is greater than a fifth threshold (e.g., 200 ms), and that the second response time of the BLE signal is always greater than the fifth threshold for a period of time (e.g., 5s). Then, the network device 110 determines that the power link is unstable or the power supplied by the power link is lower than the first threshold. The network device 110 increases the power supplied through the power link.

FIG. 20 illustrates a structural block diagram of an apparatus for acquiring link information provided in an exemplary embodiment of the present application. The apparatus may be implemented as the first device illustrated in FIG. 6, FIG. 7 or FIG. 8, or as part of the first device illustrated in FIG. 6, FIG. 7 or FIG. 8. The first device may be the network device as illustrated in FIG. 1 or FIG. 2, or the terminal device as illustrated in FIG. 1 or FIG. 2. The apparatus includes a processing module 1710. Optionally, the apparatus may further include a receiving module 1730 and/or a transmitting module 1750.

The processing module 1710 is configured to acquire state information of a power link based on a measurement result of a first signal and/or a measurement result of a second signal;
where the first signal is from a zero-power device, the second signal is transmitted by the apparatus on the power link, and the power link is used to supply power to the zero-power device.

In some embodiments, the first signal is transmitted or backscattered by the zero-power device using power supplied through the power link.

In some embodiments, a transmission parameter of the first signal is configured by the apparatus or agreed upon by a communication protocol.

In some embodiments, the transmission parameter of the first signal includes at least one of: a transmit power; a transmission period; a duration window; a duty cycle; a transmission capability level, where one transmission capability level corresponds to one mapping relationship, and the mapping relationship includes a mapping relationship between at least two transmission parameters; or a transmission capability index, where one transmission capability index is used to indicate at least one parameter of a transmit power, a transmission period, a duration window or a duty cycle.

In some embodiments, the measurement result of the first signal includes at least one of following information: a signal strength; a first response time, including a startup time required for the zero-power device to transmit or backscatter the first signal for a first time; or a second response time, including a transmission time interval between two adjacent first signals and/or an arrival time interval between two adjacent first signals.

In some embodiments, the first signal is transmitted periodically or non-periodically.

In some embodiments, a type of the first signal includes at least one of: an SRS; a DMRS; an enhanced-SRS; an SL-PRS; a sidelink broadcast signal; or a Bluetooth beacon signal.

In some embodiments, the measurement result of the second signal is determined by a second device or the zero-power device.

In some embodiments, the apparatus further includes the receiving module 1730, and the receiving module 1730 is configured to receive the measurement result of the second signal transmitted by the second device or the zero-power device.

In some embodiments, the receiving module 1730 is configured to receive feedback information transmitted by the second device or the zero-power device, and the feedback information is determined based on the measurement result of the second signal.

In some embodiments, the processing module 1710 is further configured to acquire the state information of the power link based on the feedback information.

In some embodiments, the feedback information includes at least one of following information: ACK; NACK; power sufficient; or power insufficient.

In some embodiments, the measurement result of the second signal includes at least one of following information: an RSRP value; an RSSI value; an RSRQ value; an SINR value; a CLI value; or a CSI value.

In some embodiments, a measurement configuration of the second signal is configured by the apparatus or agreed upon by a communication protocol.

In some embodiments, the measurement configuration of the second signal includes at least one of following information: a type of the second signal; a measurement frequency point of the second signal; a measurement time window of the second signal; or a measurement period of the second signal.

In some embodiments, a type of the second signal includes at least one of: a control signal; a reference signal; a synchronization signal; a sensing signal; an auxiliary signal; a wake-up signal; or a data signal.

In some embodiments, the processing module 1710 is further configured to increase or decrease power supplied through the power link based on the state information of the power link.

In some embodiments, the processing module 1710 is further configured to, in a case where the state information of the power link indicates that the power supplied through the power link is lower than a first threshold and/or the power link is unstable, increase the power supplied through the power link.

In some embodiments, the processing module 1710 is further configured to, in a case where the state information of the power link indicates that the power supplied through the power link is higher than a second threshold and/or the power link is stable, decrease the power supplied through the power link.

In some embodiments, the processing module 1710 is further configured to, in a case where a signal strength of the first signal is lower than a third threshold, and/or a first response time of the first signal is later than a fourth threshold, and/or a second response time of the first signal is greater than a fifth threshold, determine that the state information of the power link indicates that the power supplied through the power link is lower than the first threshold and/or the power link is unstable.

In some embodiments, the processing module 1710 is further configured to, in a case where the signal strength of the first signal is higher than a sixth threshold, and/or the first response time of the first signal is earlier than a seventh threshold, and/or the second response time of the first signal is less than an eighth threshold, determine that the state information of the power link indicates that the power supplied through the power link is higher than the second threshold and/or the power link is stable.

In some embodiments, the receiving module 1730 is further configured to receive request information from the zero-power device.

In some embodiments, the processing module 1710 is further configured to increase or decrease power supplied through the power link based on the request information.

In some embodiments, the processing module 1710 is further configured to, in a case where the request information is used to request an increase to the power supplied through the power link, increase the power supplied through the power link.

In some embodiments, the processing module 1710 is further configured to, in a case where the request information is used to request a decrease to the power supplied through the power link, decrease the power supplied through the power link.

In some embodiments, the request information is carried in at least one of: a preamble; a PDU; or an SR.

In some embodiments, the processing module 1710 is further configured to perform at least one of: increasing a transmit power of a signal carried by the power link; increasing a number of signals carried by the power link; increasing transmission frequency domain resources of a signal carried by the power link; increasing transmission time domain resources of a signal carried by the power link; increasing a duty cycle of a signal carried by the power link; decreasing a transmission period of a signal carried by the power link; increasing a duration corresponding to a DRX state; increasing a number of antennas corresponding to the power link; transmitting a signal on the power link using a beamforming technique; or transmitting a signal on the power link using a spatial diversity technique.

In some embodiments, the processing module 1710 is further configured to perform at least one of: decreasing a transmit power of a signal carried by the power link; decreasing a number of signals carried by the power link; decreasing transmission frequency domain resources of a signal carried by the power link; decreasing transmission time domain resources of a signal carried by the power link; decreasing a duty cycle of a signal carried by the power link; increasing a transmission period of a signal carried by the power link; decreasing a duration corresponding to a DRX state; or decreasing a number of antennas corresponding to the power link.

In some embodiments, the processing module 1710 is configured to perform one or more of the following steps: step 320, step 410, step 420, step 430, step 520, or step 530.

In some embodiments, the receiving module 1730 is configured to perform one or more of the following steps: step 410, or step 510.

In some embodiments, the apparatus further includes the transmitting module 1750, and the transmitting module 1750 is configured to transmit the second signal.

In some embodiments, the transmitting module 1750 is further configured to transmit the transmission parameter of the first signal and/or the measurement configuration of the second signal.

In summary, the apparatus provided in the embodiments of the present application supports acquiring the state information of the power link through the measurement results of the first signal and/or the second signal, thereby realizing the monitoring of the power link. This facilitates that the power supplied through the power link is subsequently adjusted in a timely manner, and thus, the communication efficiency and stability of the zero-power device are ensured.

FIG. 21 illustrates a structural block diagram of an apparatus for acquiring link information provided in an exemplary embodiment of the present application. The apparatus may be implemented as the zero-power device as illustrated in FIG. 13, FIG. 14 or FIG. 15, or as part of the zero-power device as illustrated in FIG. 13, FIG. 14 or FIG. 15. The zero-power device may be the terminal device as illustrated in FIG. 1 or FIG. 2. The apparatus includes a transmitting module 1810. Optionally, the apparatus may further include a receiving module 1830 and/or a processing module 1850.

The transmitting module 1810 is configured to transmit or backscatter a signal;
where the signal and/or information carried in the signal is used to acquire state information of a power link, and the power link is used to supply power to the apparatus.

In some embodiments, the signal includes a first signal, a measurement result of the first signal is used to acquire the state information of the power link, and the first signal is transmitted or backscattered by the apparatus using power supplied through the power link.

In some embodiments, a transmission parameter of the first signal is configured by a first device or agreed upon by a communication protocol.

In some embodiments, the transmission parameter of the first signal includes at least one of: a transmit power; a transmission period; a duration window; a duty cycle; a transmission capability level, where one transmission capability level corresponds to one mapping relationship, and the mapping relationship includes a mapping relationship between at least two transmission parameters; or a transmission capability index, where one transmission capability index is used to indicate at least one parameter of a transmit power, a transmission period, a duration window or a duty cycle.

In some embodiments, the measurement result of the first signal includes at least one of following information: a signal strength; a first response time, including a startup time required for the zero-power device to transmit or backscatter the first signal for a first time; or a second response time, including a transmission time interval between two adjacent first signals and/or an arrival time interval between two adjacent first signals.

In some embodiments, the first signal is transmitted periodically or non-periodically.

In some embodiments, a type of the first signal includes at least one of: an SRS; a DMRS; an enhanced-SRS; an SL-PRS; a sidelink broadcast signal; or a Bluetooth beacon signal.

In some embodiments, the apparatus further includes the receiving module 1830, and the receiving module 1830 is configured to receive a second signal.

In some embodiments, the receiving module 1830 is further configured to receive the transmission parameter of the first signal and/or a measurement configuration of the second signal.

In some embodiments, the apparatus further includes the processing module 1850, and the processing module 1850 is configured to measure the second signal.

In some embodiments, the signal includes a measurement result of a second signal;
where the second signal is transmitted by a first device on the power link, and the measurement result of the second signal is determined by a second device or the apparatus.

In some embodiments, the processing module 1850 is further configured to generate feedback information based on the measurement result of the second signal.

In some embodiments, the signal includes feedback information, and the feedback information is determined based on the measurement of the second signal.

In some embodiments, the feedback information includes at least one of following information: ACK; NACK; power sufficient; or power insufficient.

In some embodiments, the measurement result of the second signal includes at least one of following information: an RSRP value; an RSSI value; an RSRQ value; an SINR value; a CLI value; or a CSI value.

In some embodiments, the measurement configuration of the second signal is configured by the first device or agreed upon by a communication protocol.

The measurement configuration of the second signal includes at least one of following information: a type of the second signal; a measurement frequency point of the second signal; a measurement time window of the second signal; or a measurement period of the second signal.

In some embodiments, a type of the second signal may include at least one of: a control signal; a reference signal; a synchronization signal; a sensing signal; an auxiliary signal; a wake-up signal; or a data signal.

In some embodiments, the transmitting module 1810 is further configured to transmit request information, where the request information is used to request the first device to increase or decrease power supplied through the power link.

In some embodiments, the request information is carried in at least one of: a preamble; a PDU; or an SR.

In some embodiments, increasing the power supplied through the power link includes at least one of: increasing a transmit power of a signal carried by the power link; increasing a number of signals carried by the power link; increasing transmission frequency domain resources of a signal carried by the power link; increasing transmission time domain resources of a signal carried by the power link; increasing a duty cycle of a signal carried by the power link; decreasing a transmission period of a signal carried by the power link; increasing a duration corresponding to a DRX state; increasing a number of antennas corresponding to the power link; transmitting a signal on the power link using a beamforming technique; or transmitting a signal on the power link using a spatial diversity technique.

In some embodiments, decreasing the power supplied through the power link includes at least one of: decreasing a transmit power of a signal carried by the power link; decreasing a number of signals carried by the power link; decreasing transmission frequency domain resources of a signal carried by the power link; decreasing transmission time domain resources of a signal carried by the power link; decreasing a duty cycle of a signal carried by the power link; increasing a transmission period of a signal carried by the power link; decreasing a duration corresponding to a DRX state; or decreasing a number of antennas corresponding to the power link.

In some embodiments, the transmitting module 1810 is configured to perform one or more of the following steps: step 720, step 820, step 840, step 940, or step 960.

In some embodiments, the processing module 1850 is configured to perform step 920.

In summary, the apparatus provided in the embodiments of the present application supports both reflecting or transmitting the first signal to enable the first device to acquire the state information of the power link, and also supports acquiring the state information of the power link by the first device through the measurement result of the second signal and the feedback information, thereby realizing the monitoring of the power link. This facilitates the first device to subsequently adjust the power supplied through the power link in a timely manner, and thus, the communication efficiency and stability are ensured.

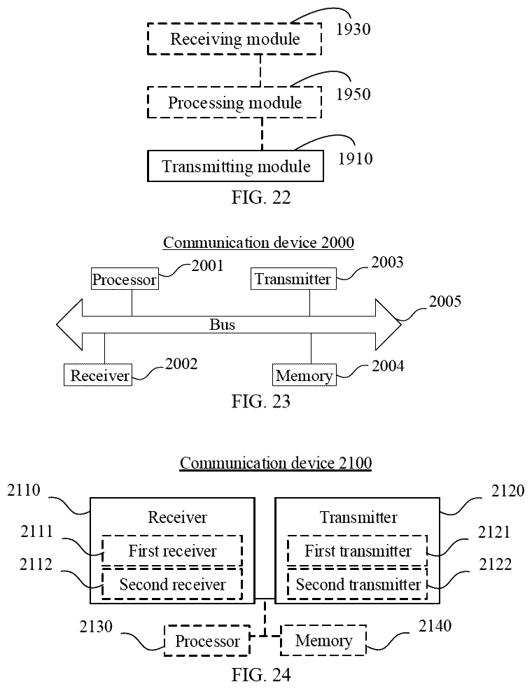

FIG. 22 illustrates a structural block diagram of an apparatus for acquiring link information provided in an exemplary embodiment of the present application. The apparatus may be implemented as the second device as illustrated in FIG. 16, or as part of the second device as illustrated in FIG. 16. The second device may be the network device as illustrated in FIG. 1 or FIG. 2, or the terminal device as illustrated in FIG. 1 or FIG. 2. The apparatus includes a transmitting module 1910. Optionally, the apparatus may further include a receiving module 1930 and/or a processing module 1950.

The transmitting module 1910 is configured to transmit a measurement result of a first signal, and/or a measurement result of a second signal, and/or feedback information;
where the measurement result of the first signal is used to acquire state information of a power link, the measurement result of the second signal is used to acquire the state information of the power link, the feedback information is used to acquire the state information of the power link, and the power link is used to supply power to a zero-power device.

In some embodiments, the first signal is transmitted or backscattered by the zero-power device using power supplied through the power link.

In some embodiments, a transmission parameter of the first signal is configured by a first device or agreed upon by a communication protocol.

In some embodiments, the transmission parameter of the first signal includes at least one of: a transmit power; a transmission period; a duration window; a duty cycle; a transmission capability level, where one transmission capability level corresponds to one mapping relationship, and the mapping relationship includes a mapping relationship between at least two transmission parameters; or a transmission capability index, where one transmission capability index is used to indicate at least one parameter of a transmit power, a transmission period, a duration window or a duty cycle.

In some embodiments, the measurement result of the first signal includes at least one of following information: a signal strength; a first response time, including a startup time required for the zero-power device to transmit or backscatter the first signal for a first time; or a second response time, including a transmission time interval between two adjacent first signals and/or an arrival time interval between two adjacent first signals.

In some embodiments, the first signal is transmitted periodically or non-periodically.

In some embodiments, a type of the first signal includes at least one of: an SRS; a DMRS; an enhanced-SRS; an SL-PRS; a sidelink broadcast signal; or a Bluetooth beacon signal.

In some embodiments, the measurement result of the second signal is determined by the second device or the zero-power device.

In some embodiments, the feedback information is determined by the apparatus and/or the zero-power device, and the feedback information is determined based on the measurement result of the second signal.

In some embodiments, the feedback information includes at least one of following information: ACK; NACK; power sufficient; or power insufficient.

In some embodiments, the measurement result of the second signal includes at least one of following information: an RSRP value; an RSSI value; an RSRQ value; an SINR value; a CLI value; or a CSI value.

In some embodiments, a measurement configuration of the second signal is configured by a first device or agreed upon by a communication protocol.

The measurement configuration of the second signal includes at least one of following information: a type of the second signal; a measurement frequency point of the second signal; a measurement time window of the second signal; or a measurement period of the second signal.

In some embodiments, a type of the second signal includes at least one of: a control signal; a reference signal; a synchronization signal; a sensing signal; an auxiliary signal; a wake-up signal; or a data signal.

In some embodiments, the transmitting module 1910 is further configured to transmit request information, where the request information is used to request a first device to increase or decrease power supplied through the power link.

In some embodiments, the request information is carried in at least one of: a preamble; a PDU; or an SR.

In some embodiments, increasing the power supplied through the power link includes at least one of: increasing a transmit power of a signal carried by the power link; increasing a number of signals carried by the power link; increasing transmission frequency domain resources of a signal carried by the power link; increasing transmission time domain resources of a signal carried by the power link; increasing a duty cycle of a signal carried by the power link; decreasing a transmission period of a signal carried by the power link; increasing a duration corresponding to a DRX state; increasing a number of antennas corresponding to the power link; transmitting a signal on the power link using a beamforming technique; or transmitting a signal on the power link using a spatial diversity technique.

In some embodiments, decreasing the power supplied through the power link includes at least one of: decreasing a transmit power of a signal carried by the power link; decreasing a number of signals carried by the power link; decreasing transmission frequency domain resources of a signal carried by the power link; decreasing transmission time domain resources of a signal carried by the power link; decreasing a duty cycle of a signal carried by the power link; increasing a transmission period of a signal carried by the power link; decreasing a duration corresponding to a DRX state; or decreasing a number of antennas corresponding to the power link.

In some embodiments, the transmitting module 1910 is configured to perform step 1020.

In some embodiments, the apparatus further includes the receiving module 1930, and the receiving module 1930 is configured to receive a measurement configuration of the first signal and/or a measurement configuration of the second signal and/or the measurement result of the second signal and/or the feedback information.

In some embodiments, the apparatus further includes the processing module 1950, and the processing module 1950 is configured to measure the first signal and/or the second signal.

In some embodiments, the processing module 1950 is further configured to generate the feedback information based on the measurement result of the second signal.

In summary, the apparatus provided in the embodiments of the present application supports the first device to feed back one or more of: the measurement result of the first signal, the measurement result of the second signal or the feedback information, to enable the first device to acquire the state information of the power link, thereby realizing the monitoring of the power link. This facilitates the first device to subsequently adjust the power supplied through the power link in a timely manner, and thus, the communication efficiency and stability of the zero-power device are ensured.

FIG. 23 illustrates a schematic structural diagram of a communication device 2000 provided in an exemplary embodiment of the present application, and the communication device 2000 includes: a processor 2001, a receiver 2002, a transmitter 2003, a memory 2004 and a bus 2005. The communication device 2000 may be used to perform at least some of the steps performed by the first device as illustrated in FIG. 6, FIG. 7 or FIG. 8, or may be used to perform at least some of the steps performed by the second device as illustrated in FIG. 16.

The processor 2001 includes one or more processing cores, and the processor 2001 executes various functional applications and information processing through running software programs and modules. In some embodiments, the processor 2001 may be configured to implement the functions and steps of the processing module 1710 and/or the processing module 1950 described above.

The receiver 2002 and the transmitter 2003 may be implemented as a communication component, the communication component may be a communication chip, and the communication component may be referred to as a transceiver. In some embodiments, the receiver 2002 may be configured to implement the functions and steps of the receiving module 1730 and/or the receiving module 1930 described above, and the transmitter 2003 may be configured to implement the functions and steps of the transmitting module 1750 and/or the transmitting module 1910 described above. In some embodiments, the receiver 2002 includes a back scattering transmitter.

The memory 2004 is connected to the processor 2001 via the bus 2005.

The memory 2004 may be configured to store at least one instruction, and the processor 2001 is configured to execute the at least one instruction to implement the various steps in the above method embodiments.

Furthermore, the memory 2004 may be implemented by any type of volatile or non-volatile storage device or a combination thereof, and the volatile or non-volatile storage device includes but not limited to: a magnetic disk or optical disk, an electrically-erasable programmable read only memory (EEPROM), an erasable programmable read only memory (EPROM), a static random access memory (SRAM), a read-only memory (ROM), a magnetic storage, a flash memory, and a programmable read-only memory (PROM).

In some embodiments, the receiver 2002 receives signals/data independently, or the processor 2001 controls the receiver 2002 to receive signals/data, or the processor 2001 requests the receiver 2002 to receive signals/data, or the processor 2001 cooperates with the receiver 2002 to receive signals/data.

In some embodiments, the transmitter 2003 transmits signals/data independently, or the processor 2001 controls the transmitter 2003 to transmit signals/data, or the processor 2001 requests the transmitter 2003 to transmit signals/data, or the processor 2001 cooperates with the transmitter 2003 to transmit signals/data.

FIG. 24 illustrates a schematic structural diagram of a communication device 2100 provided in an exemplary embodiment of the present application, and the communication device 2100 includes a receiver 2110 and a transmitter 2120. The communication device 2100 may be used to perform at least some of the steps performed by the zero-power device as illustrated in FIG. 13, FIG. 14 or FIG. 15.

The receiver 2110 and the transmitter 2120 may be implemented as a communication component, the communication component may be a communication chip, and the communication component may be referred to as a transceiver.

In some embodiments, the receiver 2110 may be configured to implement the functions and steps of the receiver module 1830 described above. Optionally, the receiver 2110 may be implemented as a first receiver 2111 and/or a second receiver 2112.

In some embodiments, the transmitter 2120 may be configured to implement the functions and steps of the transmitting module 1810. Optionally, the transmitter 2120 may be implemented as a first transmitter 2121 and/or a second transmitter 2122.

Optionally, the communication device 2100 may further include a processor 2130. The processor 2130 includes one or more processing cores, and the processor 2130 executes various functional applications and information processing through running software programs and modules. Optionally, the processor 2130 may be configured to implement the functions and steps of the processing module 1850 described above.

Optionally, the communication device 2100 may further include a memory 2140. The memory 2140 may be configured to store at least one instruction, and the processor 2130 is configured to execute the at least one instruction to implement the various steps in the above method embodiments. Furthermore, the memory 2140 may be implemented by any type of volatile or non-volatile storage device or a combination thereof, and the volatile or non-volatile storage device includes but not limited to: a magnetic disk or optical disk, an EEPROM, an EPROM, an SRAM, a ROM, a magnetic storage, a flash memory, and a PROM.

Optionally, the communication device 2100 may further include a bus (not illustrated in the figure). Optionally, the memory 2140 is connected to the processor 2130 via the bus.

In some embodiments, the receiver 2110 receives signals/data independently, or the processor 2130 controls the receiver 2110 to receive signals/data, or the processor 2130 requests the receiver 2110 to receive signals/data, or the processor 2130 cooperates with the receiver 2110 to receive signals/data.

In some embodiments, the transmitter 2120 transmits signals/data independently, or the processor 2130 controls the transmitter 2120 to transmit signals/data, or the processor 2130 requests the transmitter 2120 to transmit signals/data, or the processor 2130 cooperates with the transmitter 2120 to transmit signals/data.

In some embodiments, the first receiver 2111 is implemented as a wake-up receiver (WUR), and/or the second receiver 2112 is implemented as a main receiver.

In some embodiments, the receiver 2110 is implemented as a combined receiver of a WUR and a main receiver.

In some embodiments, the first transmitter 2121 is implemented as a main transmitter, and/or the second transmitter 2122 is implemented as a back scattering transmitter.

In some embodiments, the transmitter 2120 is implemented as a combined transmitter of a main transmitter and a back scattering transmitter.

In some embodiments, the processor 2130 and the receiver 2110 may be implemented as a single module, or the processor 2130 may be implemented as part of the receiver 2110.

In some embodiments, the processor 2130 and the transmitter 2120 may be implemented as a single module, or the processor 2130 may be implemented as part of the transmitter 2120.

In some embodiments, the communication device 2100 includes one or more processors 2130, and different processors are configured to perform the same or different steps in the steps related to the above processing.

In an exemplary embodiment of the present application, a non-transitory computer-readable storage medium is also provided, where the non-transitory computer-readable storage medium has at least one program stored thereon, and the at least one program is loaded and executed by the processor to implement the method for acquiring link information provided in the above method embodiments.

In an exemplary embodiment of the present application, a chip is also provided, where the chip includes programmable logic circuits and/or program instructions, when the programmable logic circuits and/or program instructions are executed on a communication device, the chip is configured to implement the method for acquiring link information provided in the above method embodiments.

In an exemplary embodiment of the present application, a computer program product is also provided. When the computer program product is executed on a processor of a computer device, the computer device is enabled to perform the method for acquiring link information described above.

In an exemplary embodiment of the present application, a computer program is also provided. The computer program includes computer instructions, and a processor of a computer device executes the computer instructions, to enable the computer device to perform the method for acquiring link information described above.

Those skilled in the art will understand that all or part of the steps of implementing the above embodiments may be implemented by hardware, or may be implemented by instructing related hardware through a program. The program may be stored in a non-transitory computer-readable storage medium, and the storage medium mentioned above may be a read-only memory, a disk, or an optical disk.

The above are merely optional embodiments of the present application and are not intended to limit the present application. Any modifications, equivalent substitutions, improvements and so on made within the spirit and principles of the present application shall fall within the protection scope of the present application.

What is claimed is:

1. A first device, comprising: a processor and a memory, wherein the memory is configured to store a computer program, and the processor is configured to call the computer program stored in the memory and run the computer program, to enable the first device to perform:
acquiring state information of a power link based on a measurement result of a first signal and/or a measurement result of a second signal;
wherein the first signal is from an ambient power enabled Internet of Things (A-IoT) device, the second signal is transmitted by the first device on the power link, and the power link is used to supply power to the A-IoT device.

2. The first device according to claim 1, wherein the first signal is transmitted or backscattered by the A-IoT device using power supplied through the power link; and/or
a transmission parameter of the first signal is configured by the first device or agreed upon by a communication protocol;
wherein the transmission parameter of the first signal comprises at least one of:
a transmit power;
a transmission period;
a duration window;
a duty cycle;
a transmission capability level, wherein one transmission capability level corresponds to one mapping relationship, and the mapping relationship comprises a mapping relationship between at least two transmission parameters; or
a transmission capability index, wherein one transmission capability index is used to indicate at least one parameter of a transmit power, a transmission period, a duration window or a duty cycle.

3. The first device according to claim 1, wherein the measurement result of the first signal comprises at least one of following information:
a signal strength;
a first response time, comprising a startup time required for the A-IoT device to transmit or backscatter the first signal for a first time; or
a second response time, comprising a transmission time interval between two adjacent first signals and/or an arrival time interval between two adjacent first signals.

4. The first device according to claim 1, wherein the first signal is transmitted periodically or non-periodically;
and/or
a type of the first signal comprises at least one of:
a sounding reference signal (SRS);
a demodulation reference signal (DMRS);
an enhanced-SRS;
a sidelink positioning reference signal (SL-PRS);
a sidelink broadcast signal; or
a Bluetooth beacon signal.

5. The first device according to claim 1, wherein the measurement result of the second signal is determined by a second device or the A-IoT device; and
wherein before acquiring the state information of the power link based on the measurement result of the second signal, the method further comprises:
receiving the measurement result of the second signal transmitted by the second device or the A-IoT device.

6. The first device according to claim 5, wherein acquiring the state information of the power link based on the measurement result of the second signal comprises:
receiving feedback information transmitted by the second device or the A-IoT device, wherein the feedback information is determined based on the measurement result of the second signal; and
acquiring the state information of the power link based on the feedback information;
wherein the feedback information comprises at least one of following information:
Acknowledgment (ACK);
Negative Acknowledgment (NACK);
power sufficient; or
power insufficient.

7. The first device according to claim 1, wherein the measurement result of the second signal comprises at least one of following information:
a reference signal receiving power (RSRP) value;
a reference signal strength indicator (RSSI) value;
a reference signal receiving quality (RSRQ) value;
a signal to interference plus noise ratio (SINR) value;
a cross link interference (CLI) value; or
a channel state information (CSI) value.

8. The first device according to claim 1, wherein a measurement configuration of the second signal is configured by the first device or agreed upon by a communication protocol; and
the measurement configuration of the second signal comprises at least one of following information:
a type of the second signal;
a measurement frequency point of the second signal;
a measurement time window of the second signal; or
a measurement period of the second signal;
and/or
wherein a type of the second signal comprises at least one of:
a control signal;
a reference signal;
a synchronization signal;
a sensing signal;
an auxiliary signal;
a wake-up signal; or
a data signal.

9. An ambient power enabled Internet of Things (A-IoT) device, comprising: a transmitter; wherein the transmitter is configured to:
transmit or backscatter a signal;
wherein the signal and/or information carried in the signal is used to acquire state information of a power link, and the power link is used to supply power to the A-IoT device.

10. The A-IoT device according to claim 9, wherein the signal comprises a first signal, a measurement result of the first signal is used to acquire the state information of the power link, and the first signal is transmitted or backscattered by the A-IoT device using power supplied through the power link;
a transmission parameter of the first signal is configured by a first device or agreed upon by a communication protocol; and
the transmission parameter of the first signal comprises at least one of:
a transmit power;
a transmission period;
a duration window;
a duty cycle;
a transmission capability level, wherein one transmission capability level corresponds to one mapping relationship, and the mapping relationship comprises a mapping relationship between at least two transmission parameters; or
a transmission capability index, wherein one transmission capability index is used to indicate at least one parameter of a transmit power, a transmission period, a duration window or a duty cycle.

11. The A-IoT device according to claim 10, wherein the measurement result of the first signal comprises at least one of following information:
a signal strength;
a first response time, comprising a startup time required for the A-IoT device to transmit or backscatter the first signal for a first time; or
a second response time, comprising a transmission time interval between two adjacent first signals and/or an arrival time interval between two adjacent first signals.

12. The A-IoT device according to claim 10, wherein the first signal is transmitted periodically or non-periodically;
and/or
a type of the first signal comprises at least one of:
a sounding reference signal (SRS);
a demodulation reference signal (DMRS);
an enhanced-SRS;
a sidelink positioning reference signal (SL-PRS);
a sidelink broadcast signal; or
a Bluetooth beacon signal.

13. The A-IoT device according to claim 9, wherein the signal comprises a measurement result of a second signal; and
the second signal is transmitted by a first device on the power link, and the measurement result of the second signal is determined by a second device or the A-IoT device.

14. The A-IoT device according to claim 9, wherein the signal comprises feedback information; and
the feedback information is determined based on a measurement result of a second signal;
wherein the feedback information comprises at least one of following information:
Acknowledgment (ACK);
Negative Acknowledgment (NACK);
power sufficient; or
power insufficient.

15. The A-IoT device according to claim 13, wherein the measurement result of the second signal comprises at least one of following information:
a reference signal receiving power (RSRP) value;
a reference signal strength indicator (RSSI) value;
a reference signal receiving quality (RSRQ) value;
a signal to interference plus noise ratio (SINR) value;
a cross link interference (CLI) value; or
a channel state information (CSI) value.

16. The A-IoT device according to claim 13, wherein a measurement configuration of the second signal is configured by the first device or agreed upon by a communication protocol; and
the measurement configuration of the second signal comprises at least one of following information:
a type of the second signal;
a measurement frequency point of the second signal;
a measurement time window of the second signal; or
a measurement period of the second signal;
and/or
wherein a type of the second signal comprises at least one of: a control signal; a reference signal; a synchronization signal; a sensing signal; an auxiliary signal; a wake-up signal; or a data signal.

17. A second device, comprising: a processor and a memory, wherein the memory is configured to store a computer program, and the processor is configured to call the computer program stored in the memory and run the computer program, to enable the second device to perform:
transmitting a measurement result of a first signal, and/or a measurement result of a second signal, and/or feedback information;
wherein the measurement result of the first signal is used to acquire state information of a power link, the measurement result of the second signal is used to acquire the state information of the power link, the feedback information is used to acquire the state information of the power link, and the power link is used to supply power to an ambient power enabled Internet of Things (A-IoT) device.

18. The second device according to claim 17, wherein the first signal is transmitted or backscattered by the A-IoT device using power supplied through the power link; and/or
a transmission parameter of the first signal is configured by a first device or agreed upon by a communication protocol;
wherein the transmission parameter of the first signal comprises at least one of:
a transmit power;
a transmission period;
a duration window;
a duty cycle;
a transmission capability level, wherein one transmission capability level corresponds to one mapping relationship, and the mapping relationship comprises a mapping relationship between at least two transmission parameters; or
a transmission capability index, wherein one transmission capability index is used to indicate at least one parameter of a transmit power, a transmission period, a duration window or a duty cycle.

19. The second device according to claim 17, wherein the measurement result of the first signal comprises at least one of following information:
a signal strength;
a first response time, comprising a startup time required for the A-IoT device to transmit or backscatter the first signal for a first time; or
a second response time, comprising a transmission time interval between two adjacent first signals and/or an arrival time interval between two adjacent first signals.

20. The second device according to claim 17, wherein the first signal is transmitted periodically or non-periodically;
and/or
a type of the first signal comprises at least one of:
a sounding reference signal (SRS);
a demodulation reference signal (DMRS);
an enhanced-SRS;
a sidelink positioning reference signal (SL-PRS);
a sidelink broadcast signal; or
a Bluetooth beacon signal.
